(19) United States
(12) Patent Application Publication
(10) Pub. No.: US 2018/0352839 A1
(43) Pub. Date: Dec. 13, 2018

(54) METHOD FOR THE PREPARATION OF PICKLED POTATO STRINGS

(71) Applicant: HZPC HOLLAND B.V., Joure (NL)

(72) Inventor: Johannes Elisabert VAN DOORN, Joure (NL)

(21) Appl. No.: 16/003,312

(22) Filed: Jun. 8, 2018

Related U.S. Application Data
(63) Continuation of application No. 15/743,588, filed on Jan. 10, 2018.

(30) Foreign Application Priority Data
Jul. 10, 2015 (NL) 2015152
Jul. 10, 2015 (NL) 2015154

(51) Int. Cl. A23L 19/18

(52) U.S. Cl. CPC A23L 19/18; A23V 2002/00

(57) ABSTRACT

Described is a method for the preparation of dried crunchy potato bodies as consumable upon rehydration, comprising the steps of providing potatoes, cutting the potatoes of step in bodies having a thickness of 3.5 mm or less, heating the potato bodies of step to a temperature of 140° C. or less, blast chilling the heated potato bodies to 10° C. or less, and drying the potato bodies to a dry matter content of at least 90 w/w % at a temperature below 0° C. Also described is a method for the preparation of pickled potato strings, comprising the steps of providing potatoes, cutting the potatoes in strings having a cross-sectional area of 25 mm² or less, heating the potato strings, blast chilling the heated potato strings and incubating the blast chilled tomato strings in a liquid pickling medium having a pH of between 3 and 4.5 at elevated temperature.

### CROSS REFERENCE TO RELATED APPLICATIONS

The present application is a continuation of U.S. patent application Ser. No. 15/743,588, filed Jan. 10, 2018, which is a Section 371 U.S. national stage entry of International Patent Application No. PCT/NL2016/050477, International Filing Date Jul. 5, 2016, which claims the benefit of NL Patent Application No. 2015152, filed Jul. 10, 2015 and NL Patent Application No. 2015154, filed Jul. 10, 2015, the contents of which are incorporated by reference in their entireties.

Method for the preparation of dried crunchy potato bodies as consumable upon rehydration, to a method for the determination of suitability of a batch of potatoes for use in said method, to potato bodies obtainable by the said method, to a dry soup or sauce mix comprising the potato bodies, to a method for enrichment of soup or sauce and to a snack, soup, noodle product or sauce comprising the potato bodies.

In the art, cut potato products, herein also potato bodies, are known for use in a plurality of food products. For example, French fries and chips or crisps are such known potato bodies, that are prepared by frying the potato bodies in oil. Also French fries are known that are to be heated by air in an oven, wherein no or less oil is used. Also, potato noodles, also known as gnocchi in the Italian kitchen, “Nudeln” in the German kitchen or Czech or Slovakian dumplings have a dense, moist and sticky texture and various roll and circular shapes and forms. French fries, chips and the potato noodles are all made from high dry matter potatoes, having a specific gravity of usually 1,078 or higher. It has hitherto not been possible to prepare dried potato bodies from batches of potatoes in a production process, that remain crunchy upon rehydration.

In an attempt to produce potato strings as soup ingredient having crunchiness of crouton-like products, made from toasted bread, the inventors observed that in general a noodle like product is obtained having a soft, chewy, starchy, granular and gluey texture and structure upon preparation in hot water. This texture quickly deteriorates further and the strings finally start to fall apart after standing times of 5 minutes or more. Such potato bodies are far from crunchy and are not suitable to be used as instant noodle ingredients in noodle based products and instant soups because of their poor texture performance and undesirable and unpleasant eating experiences. Such potato bodies, such as strings lack integrity characteristics because a major requirement for noodles as ingredient is the lack of disintegration of the strings upon preparation.

In the art, methods are known for the preparation of dried potato pieces that are intended to be rehydrated, however, such methods result at best in rehydrated potato pieces that produce potato pieces similar to a freshly boiled potato, but not in rehydrated potato pieces that have a crunchy texture after rehydration. For example U.S. Pat. No. 3,438,792 discloses a combined freeze drying and air drying process for dehydrating food such as potatoes. U.S. Pat. No. 3,644,129 describes a method comprising two blanching and subsequent cooling steps, followed by the combined freeze and air drying steps of U.S. Pat. No. 3,438,792. Potato pieces are blanched for 5 to 30 minutes at 71-82° C., followed by cooling for 5 to 30 minutes at 0.5-27° C., another heating at 71° C., freezing at −28 to −17° C. until up to 50 percent of the weight is lost, followed by drying in air at a temperature of 60-77° C. to reduce the moisture content to 7 percent by weight or less. This multistep procedure is cost intensive and does not result in potato pieces that are crunchy upon rehydration.

The present inventors have now developed a method for the preparation of dried crunchy potato bodies as consumable upon rehydration, that remain crunchy once rehydrated, even in hot water for periods of up to 30 minutes and longer, rendering the said potato bodies extremely suitable as crispy component in soups, noodle products and sauces, or as crispy low calorie snacks that are rehydrated by the saliva in the oral cavity, as the preparation method does not need any contacting of the potato bodies with oil.

To this end, disclosed is a method for the preparation of dried crunchy potato bodies as consumable upon rehydration, comprising the steps of:
a) Providing potatoes,
b) Cutting the potatoes of step a) in potato bodies having a thickness of 3.5 mm or less,
c) Heating the potato bodies of step b) to a temperature of 140° C. or less,
d) Blast chilling the heated potato bodies of step c) to 10° C. or less,
e) Drying the blast chilled potato bodies of step d) to a dry matter content of at least 90 w/w % at a temperature below 0° C.,
f) Providing the potato bodies of step e) as consumable to be rehydrated on consumption.

Dried potato bodies prepared by this method, also named “instant freeze dried potato bodies’, surprisingly keep their initial crunchy texture when allowed to rehydrate in hot water, soup or sauce. The dried potato bodies also have a crunchy, crispy and brittle texture characteristics upon consumption as a snack and saliva stimulating properties. The potato bodies, as rehydrated in hot water, soup or sauce have a long-lasting pretty and crunchy texture. In hot water or soup or as rehydrated noodle, the crunchiness is maintained for up to over 30 minutes, which is in great contrast with e.g. croutons, prepared from toasted read, that lose their crunchy character in hot soup within minutes. The instant freeze-dried potato bodies have the property to float or suspend evenly distributed in the soup upon preparation giving a homogeneous distribution of the potato bodies. Also, the obtained dried potato bodies provide for very attractive snacks when consumed in dry form. On consumption, the potato bodies are contacted with saliva in the oral cavity, resulting in rehydration thereof, while triggering a series of sensorial experiences. The body therewith gives a trigger to produce more saliva, which give the consumer a pleasant juicy experience, while enjoying a crispy, brittle and melting snack product. The instant potato bodies can e.g. be used as snacks, or as an ingredient in a wide range of food products such as soups and sauces, e.g. in tomato-based pasta sauces, giving the prepared products a combination of flavour and texture sensations including a crunchy sound during the chewing of the potato bodies.

The term ‘consumable’ is intended to mean any food product or food ingredient, that preferably retains its shape when used as food ingredient, said shape being destroyed upon chewing upon consumption. Rehydration on consumption means that rehydration can take place when the potato bodies, as food ingredient, are brought in contact with the food to be consumed, taking up the water for rehydration from the said food, or can also take place by saliva in the oral cavity.

The potatoes are preferably peeled before or during the cutting step b). Peeling of the potatoes can e.g. be performed and automated with any knife or abrasive based peeler at room temperature, but not by heat operated peelers, to avoid heat pre-treatment on the tubers during the production process prior to the cutting of potatoes into the potato bodies. It is also possible however to provide the potatoes unpeeled, but preferably at least washed.

Cutting of the potatoes to bodies can be performed by any suitable device and can be automated. The potato bodies can have any desirable form, but the thickness is limited. Above a thickness of 3.5 mm, the potato bodies are not sufficiently heated in the subsequent heating step, or the potato bodies become overcooked at the surface while still being raw inside. Such potato bodies will lose the crunchy texture at the surface thereof while still being unpleasantly hard at the inside when being rehydrated and consumed. The term ‘having a thickness of 3.5 mm or less’ therefore means that the potato body does not have a thickness, not only uniformly but preferably also not locally, exceeding 3.5 mm.

Preferably, the potato bodies are washed after the cutting step b) to remove excess of starch.

In step c), the cut potato bodies, obtained in step b) are heated, preferably after a washing step. Without such, preferably immediate, heating step, i.e. in case cut potato bodies are produced to a freeze dried product without heating treatment of step c), such dried potato bodies result in an inferior product with poor texture and appearance upon rehydration. The potato bodies will deteriorate fast in terms of texture and firmness possibly due to triggered oxidation processes upon cutting. Heating can take place e.g. by blanching the potato bodies in boiling water, or by steaming at a higher temperature, or by any other suitable heating method known in the art. The term ‘blanching’ is intended to mean the heating of the potato bodies with hot water or steam to obtain a product with optimal taste, texture and appearance when used as food, such as a snack, or as food component in e.g. soup and sauces. To this end it is important that the potato bodies, having the right thickness as defined herein, are brought in a sufficient volume of hot water or steam so that optimal heat exchange between the potato bodies and the hot water can take place. The higher the heating temperature, the shorter the heating is usually to be performed. For example, if blanching in boiling water is chosen as heating method, the heating time may e.g. vary between 30 seconds and 4 minutes, which can be determined by the skilled person. When the bodies are heated by steam of e.g. 120° C., the heating time will be less, e.g. 15 seconds to one minute. The minimum temperature for effective blanching is preferably 60° C., more preferably 70° C., even more preferably 80° C. and typically the minimum temperature is in the range of 80-90° C. for a product with good texture, appearance and microbiological specifications. To optimize heating, the heat exchange surface between the potato bodies and the heating medium (steam, water) is preferably as large as possible to ensure even heat distribution through the potato bodies. To this end, the surface of the potato bodies is preferably fully contacted with the heating medium, e.g. by submersion in a rather large volume of liquid heating medium in order to minimize contacting of the potato bodies with one another during heating. Heating is preferably be performed by contacting the potato bodies with water or steam of the envisaged temperature.

Importantly, the potato bodies are blast chilled after heating in particular to prevent overcooking of the product. The terms ‘blast chilling’ and ‘flash cooling’ have identical meanings and are therefore interchangeably used herein, and are intended to mean that the potato bodies are cooled fast to 10° C. or less, i.e. within 25 minutes, preferably within 15 minutes, even more preferably in 10 minutes or less, still even more preferably in 8 minutes or less, still even more preferably in 6 minutes or less and most preferably in 5 minutes or less. Although the above definition prevails, a more general definition of blast chilling is e.g. given in the Brochure NJB0497 Blast Chill Freeze and Thaw Blue Paper November 2009, retrievable from the website http://www.fosterrefrigerator.co.uk The potato bodies are contacted with a cooling medium, which can be any suitable cooling medium, preferably a fluid, such as a cooling gas or liquid, e.g. cold air or water. A cooling gas, in particular cold air is preferred. To optimize cooling, the heat exchange surface between the potato bodies and the cooling medium is preferably as large as possible. Preferably, the surface of the potato bodies is fully contacted with the cooling medium, e.g. by submersion in a rather large volume of liquid cooling medium in order to minimize contacting of the potato bodies with one another during cooling. The temperature of the cooling medium can be the same as, or lower than the temperature whereto the potato bodies are to be cooled. When a faster flash cooling is preferred, the temperature of the cooling medium can accordingly be chosen lower than the temperature whereto the potato bodies are to be cooled. However, in a preferred embodiment, the temperature of the cooling medium is the same as the temperature whereto the potato bodies are to be cooled.

In step e), the blast chilled potato bodies of step d) are dried to a dry matter content of at least 90 w/w % at a temperature below 0° C. This freeze-drying step results in stable dry potato bodies that, upon rehydration in the food, are and remain crunchy as explained above. The skilled person is aware of suitable freeze-drying techniques. For example, step e) can be performed for about 24 hours in professional freeze-driers preferably equipped with heated shelves to allow a quick drying process and to obtain high quality freeze-dried potato bodies.

According to the invention, preferably no additional blanching and cooling steps are performed, as is done in the method of U.S. Pat. No. 3,644,129, where two blanching steps at relatively low temperatures are performed, the first blanching step being followed by a relatively low cooling step of 5-30 minutes. According to the invention the dried potato pieces that are crunchy after rehydrating can be obtained by a single blanching step and preferably also a single cooling step. Further, it is to be observed that according to the invention, a single drying step is performed at a temperature of below 0° C. until the potato pieces have a dry matter content of at least 90 w/w %, whereas according to U.S. Pat. No. 3,644,129, a two-step drying method is applied, the first being a freeze drying step until a dry matter content of at most 50 w/w % is obtained, and followed by air drying at elevated temperature of 60-77° C. to reduce the dry matter content further to 7 w/w %. Such additional drying step at elevated temperature, and also the additional blanching step do not result in potato pieces that are crunchy upon rehydration. In contrast, steps c), d) and e) are performed subsequently, without additional blanching and heating steps.

In preferred embodiment, the potato bodies are cut to a thickness of 3 mm or less. Bodies having such a thickness can conveniently be heated evenly throughout the entire mass thereof in a rather short heating period. The potato bodies are preferably cut to a thickness of 1 mm or more, preferably of 2 mm or more, most preferably to a thickness of about 2.5 mm, as heating thinner bodies with a thickness of less than 1mm² may easily result in overcooking, and loss of texture, rendering the process difficult to handle.

In an attractive embodiment, the potatoes are cut in step b) to potato bodies having the shape of a disc, strip, sphere, ellipsoid or string, which are all attractive shapes for food or food ingredients. In particular for snacks, the shape of a disc is attractive, like that of chips or crisps. As food ingredient, e.g. in soup, a strip shape or string shape may be more preferred, whereas in a sauce, spheres or ellipsoids may be preferred. The skilled person is aware of many suitable shapes for the envisaged aim. For example, disc or plate shaped potato bodies can be punched to smaller bodies having a certain fantasy shape, e.g. resembling an image of a clown face, or may have the form of characters, as is known for soup vermicelli.

In step b), the potatoes are preferably cut to potato bodies having a maximum cross-sectional area of 300 mm² or less, meaning that the cross sectional area does not exceed 300 mm². E.g. when the potato bodies are disc-shaped, the cross sectional area is variable and not uniform, having a maximum defined by the diameter of the disc. Preferably, the said cross-sectional area is 250 mm² or less, more preferably of 200 mm² or less. Such potato bodies have an attractive size for the consumer. For disc shaped potato bodies, a diameter of 200 to 800 mm is preferred.

In another preferred embodiment the potatoes are cut, in step b) to strings having a uniform circular or rectangular cross-sectional area, preferably over the entire length or applicable dimensions thereof. In order to produce elongated string shaped potato bodies according the method of the invention, potatoes are preferably cut in the natural length direction of the tubers, by passing these through a sharpened grid, resulting in a uniform length of the bodies, which is in contrast to potato bits used for e.g. the food product “Rösti”, known in Swiss cuisine. The above may result in strip and string shaped forms. Although the said cross sectional area of the potato strings can have any form, such as round, rectangular or irregular, a square form is preferred as this form minimizes losses in cutting of the potatoes.

In a preferred embodiment, the potato bodies in step b) are cut to a cross-sectional area of 25 mm² or less, preferably of 20 mm² or less, more preferably 16 mm² or less, even more preferably of 10 mm² or less, most preferably of 7 mm² or less, preferably resulting in small sized potato bodies having a varying cross sectional area, such as discs, or in string shaped potato bodies having a substantially uniform cross sectional area. The said cross-sectional area is preferably at least 3 mm², more preferably at least 4 mm² and most preferably at least 5 mm². Care has to be taken when the cross-sectional area becomes too small as compared to the surface of the bodies. When the potato bodies have a too large surface to volume ratio, the bodies will tend to become overcooked when heated. In contrast, the larger the cross-sectional area, the greater the chance that upon heating, the inside of the bodies are still hard and raw whereas the outside is already soft, resulting in uneven heating and an inferior product.

Preferably, the potato strings are cut, preferably in the natural length direction of the tubers, in step b) to have a rectangular cross-sectional area, preferably a square. As indicated above, cutting into such strings results in less material losses than when cut to cylindrical strings, i.e. a circular cross sectional area. A square form is preferred for practical and economic reasons.

The skilled person will be capable to select the proper heating parameters for potato body heat treatment such as temperature, heating time and the way of heat transfer, such as by incubation of the potato bodies in hot water or by treatment with steam, all as function of scale of production and processing equipment available.

Preferably, potato bodies should meet particular texture requirements after the heating process, before being blast-chilled and dried. To this end, a texture protocol has been designed for the measurement of texture parameters of heat-treated potato strings as reference shape for potato bodies. Potato strings have been found to be the optimal shape for the execution of texture measurements according to cutting principles. Results obtained from texture measurements on such potato strings are indicative for the suitability of the potatoes for use in the dried potato body production method of the invention. Thereto, in step c) the heating is chosen such, that a texture measurement on the heated potato strings after step c) according to the following protocol:
i. loading 160 g of heated potato strings having a cross sectional area of 2.5×2.5 mm, of which at least 90% has a length of 30-150 mm, directly after the said step c) in a chamber having a top and a bottom wall, a height of 40 mm, a length of 100 mm and a width of 70 mm, which top wall has 3 slits, each having a length of 65 mm and a width of 5 mm, the slits having a distance of 2 cm to one another and oriented in parallel to one another, and perpendicular to the axis of the chamber,
ii. closing the chamber,
iii. moving sequentially through each slit in vertical direction towards the bottom wall of the chamber with a speed of 1.0 mm/s over a distance of 24 mm, a probe cutting blade having a lower cutting portion having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion, the length thereof rejuvenating over a height of 34 mm to an upper side having a length of 46 mm and a thickness at the upper side of 2 mm, the thickness of the blade portion rejuvenating from the upper side thereof with an angle of 1° between the front and back side thereof towards the cutting portion, said cutting portion rejuvenating from the upper side thereof with an angle of 6° between the front and back side thereof to the lower sharp cutting edge with a calibrated sharpness of 2.08-2.44 N,
iv. during said moving, measuring the resistance force exerted on the blade as soon as the said force exceeds a threshold of 0.49 N, steps i.-iv. being performed at 60° C.,
v. repeating steps i.-iv., resulting in 6 measurements,
vi. calculating the parameters Fmax (maximum average resistance force) and SA (average surface area, defined as the surface under a graph, reflecting the resistance force curve in time during each measurement of steps iv.) from the 6 measurements wherein outlier values outside the 95% confidence interval by variance analysis (ANOVA) are excluded from the calculation,
   results in an Fmax of at least 12 N above the threshold, and SA of at least 130 Ns.

When the potato strings fulfil the above texture requirements, it has been found that an optimal potato product can be obtained having optimal texture qualities such as bite and crispiness after being rehydrated as consumable in the previously described products such as soups, noodles, sauces and snacks. In a first step of the texture measurement, the heated potato strings are allowed to cool down to 60° C., and 160 gram are weighted and put evenly in the container which is subsequently closed. The texture measurement, i.e. steps i.-iv. are performed at 60° C., preferably in a thermostatised room, such as a Peltier cabinet wherein the temperature is regulated to be 60° C. The closed container is preferably at 60° C. Once the potato strings are loaded in the chamber, the chamber is closed and a probe blade of the above described dimensions and sharpness is moved with a constant speed of 1.0 mm/s through the slits and through the potato strings for 2.4 cm, confined in the chamber. The sharpness of the blade is defined by the average of 6 values, obtained by double measurements at three locations on the sharp cutting edge of the blade being uniformly sharpened, i.e. at the middle of the cutting edge between the rounded edges (at 2.65 mm from both edges) and at 1.8 mm from the said middle towards both rounded edges. The measurements are to be performed by using a CATRA Razor Edge Sharpness tester (REST) (CATRA, Henry Street , Sheffield, S3 7EQ, UK) and by applying the suppliers' calibration protocol, the detailed principles of the said standardized test protocol being in the following link (herein incorporated by reference):

http://www.catra.org/pages/products/kniveslevel1/st.htm, resulting in a sharpness in the above range of 2.08-2.44 N.

As soon as the resistance force of the probe blade reaches a threshold of 0.49N, the said force is registered while the blade continues to move through the confined potato strings. The maximum force is an indication of the crispiness. If the maximum force is too low, it has been found that the resulting stir-fried product after storage gives a too weak, mealy and spongy product. When a force-time curve is produced in a graph showing the resistance force, exerted by the confined potato strings to the probe blade in time, the Fmax reflects the bite or firmness of the potato strings while the SA (surface under the curve) is associated to the amount of labour needed to disintegrate, chew and clear the product upon consumption. If the SA value is too low, the strings are too soft and overdone relative to the target texture profile, which has been found to result in a dried potato string product of bad texture both as dry snack and as rehydrated product. A total of 6 texture measurements are obtained per potato strings sample, comprised of two triplicate observations on a replicate product sample. Outlier values outside the 95% confidence interval by variance analysis (ANOVA using GenStat 14^{th} Edition software) are excluded from the calculation. Preferably, at most 2 of the 6 calculated values are outside the 95% confidence interval. If more than 2 of the 6 calculated values are outside the said confidence interval, the desired texture requirements are not met. The Fmax is at least 12, preferably 13 N, most preferably 14 N above the threshold. The SA is at least 130 Ns, preferably at least 140 Ns.

If the above texture requirements are met, proper heating conditions are therewith identified to perform the method of the present invention to produce the potato bodies with the envisaged qualities. The skilled person is free to choose the heating procedure he prefers, as long as, in this preferred embodiment, the texture values are met.

In another preferred embodiment, the time T_{FP} to reach a first peak on the time-force curve during a texture measurement is 14-21 s, preferably 15-20 s. The time to reach the first peak is an indication about the packing quality of the product in the container. If the first peak is reached too early, i.e. before 14 s, it is an indication that the product is packed too dense or uneven resulting in first peak values before 14s. If the first peak is realized late in the cycle, i.e. after 21 seconds it is an indication that the container is filled too loose with strings with late first peak timing as result. If time T is outside the above range of 14-21 s, or preferably outside 15-20 s, the texture measurement should be repeated by reloading the chamber more evenly, as otherwise, the average resistance force as calculated in step vi. will be unreliable.

In another preferred embodiment, the time T_{FM} to reach Fmax during a texture measurement is 15-24 s. The process of movement of the probe blade through the confined potato strings takes 24 seconds, so the Fmax should preferably be realised relative late during the measurement as force builds gradually up to its maximum during the texture measurement process. The Fmax of a strings sample and the time T to reach this value are dependent on two principles, (1) the texture of the product in terms of soft to firm and (2) the quality of the packing of the product in the container in terms of (un)even density. With respect to texture, typical Fmax values between 5-25N can be observed for ready-to-use potato strings, values that are realized between 15 and 24 seconds in the test protocol if the strings are properly evenly packed. An initial hard bite is experienced at Fmax values above 20N, associated with a relative raw or under processed product. Such a bite is less desired for the potato strings of the invention. The same is true when the Fmax is below 12N, indicating an initial soft overcooked texture.

Preferably, the potato bodies in step c) are heated to 120° C. or less, preferably to about 100° C. (the term ‘about’ would allow a temperature variation of 5° C. around the indicated value, preferably of 3° C., more preferably 1° C. and most preferably 0° C.). It has been found that at higher temperatures, the heating time is usually short, i.e. below 1 minute, which makes the process to be performed on industrial scale more complicated. The risk of over cooking is relatively high, resulting in a too soft texture. The potato bodies in step c) are preferably heated to at least 60° C., more preferably to at least 70° C., even more preferably to at least 80° C., most preferably to at least 90° C.

In step c) of the method of the present invention, the heating time is preferably 360 s. or less, more preferably 240 s. or less, even more preferably 60 s. or less. Shorter times are possible, but from an industrial feasibility point of view, less desired, as explained above. The heating time is preferably at least 30 s., more preferably at least 50 s. Preferably, the potato bodies in step c) are blanched in boiling water, in particular for 1 minute, or by steam. Good results are obtained when 1 kg of potato bodies, in particular strings are blanched during 1 minute in 26 litre of boiling water. However, it should be noted that the texture values Fmax and SA preferably comply with the above values.

It has been found that the dry matter content of the potato bodies should preferably not be higher than 20 w/w %, preferably be between 16-19 w/w % during at least steps a), b) and c) of the preparation method. It was found that during these steps of the method, the dry matter content in the potato bodies does not significantly change upon heat treatment as compared with that of the potatoes initially provided in step a), meaning that the dry matter content does not significantly vary, i.e. by ca. 0.5 w/w % or less. It is believed that such maintenance of the dry matter content is important for the consumption quality of the crunchy potato bodies as prepared according to the preparation method described herein. It has been found that maintaining the dry matter content within 16 and 19 w/w %, in particular during step c) results, upon rehydration, in potato bodies with optimal texture, structure and integrity properties. This is preferably achieved by avoiding oil contact with the potato bodies or at least to minimize contact with oil during the production process and in particular during step c). Preferably, potatoes having a dry matter content of between 16 and 19 w/w % are provided for the preparation of potato strings according to the invention.

It is to be understood that the step d) of blast chilling, or flash cooling, is preferably performed for 10 minutes or less, more preferably for 8 minutes or less, even more preferably for 6 minutes or less, and most preferably for 5 minutes or less, in particular 4 minutes or less, or 3 minutes or less. In an embodiment, blast chilling takes place above the freezing point, in step d) the heated potato strings can e.g. be blast chilled to 7° C. or less, or to 3-5° C., i.e. at a temperature of common household and industrial refrigerators. Blast chilling can be performed in any way known to the skilled person, and suitable flash cooling or blast chilling instruments are known, for example those of Foster, UK. Flash cooling is necessary to stop the cooking process in the potato bodies in order to avoid the bodies to become too soft, resulting in impaired texture of the envisaged product. In industrial processes, flash cooling can be very fast e.g. by using liquid nitrogen or solid CO₂ (so—called dry ice) to generate an air flow of very low temperature. In such a case, the time can be reduced to several seconds. In case the product is frozen as a result of blast chilling, the process is also called ‘blast freezing’.

In a preferred embodiment, the strings are blast chilled, i.e. blast frozen below the freezing point of water, preferably below −5° C., particularly between −10° C. and −25° C., which brings the potato bodies to suitable temperature conditions for the freeze drying step e) to be performed. A blast freezing step as cooling step is a very attractive treatment to arrest the heat treatment, preventing overcooking of the potato bodies and brings the potato bodies temperature wise in optimal conditions for the subsequent freeze drying step.

For optimal cooling, the step of blast chilling or blast freezing preferably comprises contacting the potato strings with a forced stream of cooling fluid, such as cooling gas or air, preferably having a temperature of −1° C. to −30° C. Cooling of potato bodies as treatment to arrest the influence of blanching, thus preventing overcooking, is preferably executed until the product is frozen at a temperature of −15 to -25° C., preferably until ca. −20° C. This is effectively achieved by blast freezing of the product to this desired temperature and meets subsequent freeze drying requirements.

In an attractive embodiment, the potato bodies are freeze dried in step e) to a dry matter content of at least 95 w/w %, most preferable at least 98 or 99 w/w %. This not only results in a prolonged shelf life without the need for refrigeration, but also the crunchiness and crispiness of the dried potato bodies becomes optimal at a dry matter % above 99%, even better above 99.5% dry matter and still even better above 99.8% dry matter.

As indicated above, steps blast chilling step d) and freeze drying step e) are performed successively while the potato bodies are blast chilled or frozen to the envisaged temperature of the freeze drying step, resulting in a very cost effective process. To this end, the blast chilling is done at the temperature of the freeze drying. Thereto, the cooling step d) the potato strings are preferably cooled to the temperature of drying step e), preferably to −15 to −25° C. The freeze drying step can immediately commence after the heated potato bodies of step c) are blast chilled to a frozen product. It is also possible to keep the potato bodies frozen after the blast chilling step until the potato bodies are subjected to the freeze drying step.

The method is preferably oil free, meaning that the potato bodies are not contacted with oil as from the moment the potatoes are cut into bodies until blast chilling.

The method preferably comprises a step f) of packaging and sealing the dried potato bodies of step e) in containers, preferably plastic bags. However, any suitable container can be used. Freeze-dried potato bodies are preferably stored in dry & dark places under vacuum or modified atmosphere to maintain optimal texture, colour and flavour and to prevent oxidation.

In another embodiment, the method further comprises a step g) of providing the potato bodies of step e) or f) as consumable to be rehydrated on consumption.

The consumable is preferably a snack or a component for soup or sauce.

The invention also relates to a method for the determination of suitability of a batch of potatoes of a variety or different varieties to be used in the method for the preparation of potato bodies as described above. To this end, a texture protocol has been designed for the measurement of texture parameters of heat-treated potato strings as reference shape for potato bodies. In this method, the texture of potatoes is tested after a defined heating step of 3 minutes blanching in boiling water, wherein preferably 1 kilogram of cut potatoes is used, comprising the following steps:
A) providing peeled potatoes,
B) cutting the peeled potatoes in strings with a cross sectional area of 2.5×2.5 mm, of which at least 90% has a length of 30-150 mm,
C) blanching the said potato strings in boiling water during 3 minutes,
D) loading 160 g of the blanched potato strings in a container having a top and a bottom wall, a height of 40 mm, a length of 100 mm and a width of 70 mm, which top wall has 3 slits, each having a length of 65 mm and a width of 5 mm, the slits having a distance of 2 cm to one another and oriented in parallel to one another, and perpendicular to the axis of the chamber,
E) closing the chamber, moving sequentially through each slit in vertical direction towards the bottom wall of the chamber with a speed of 1.0 mm/s over a distance of 24 mm, a probe cutting blade having a lower cutting portion having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion, the length thereof rejuvenating over a height of 34 mm to an upper side having a length of 46 mm and a thickness at the upper side of 2 mm, the thickness of the blade portion rejuvenating from the upper side thereof with an angle of 1° between the front and back side thereof towards the cutting portion, said cutting portion rejuvenating from the upper side thereof with an angle of 6° between the front and back side thereof to the lower sharp cutting edge with a calibrated sharpness of 2.08-2.44 N,
F) during said moving, measuring the resistance force exerted on the blade as soon as the said force exceeds a threshold of 0.49 N, steps D)-F) being performed at 60° C.,
G) repeating steps D)-G), resulting in 6 measurements,
H) calculating the parameters Fmax (maximum average resistance force) and SA (average surface area, defined as the surface under a graph, reflecting the resistance force curve in time during each measurement of steps G) from the 6 measurements wherein outlier values outside the 95% confidence interval by variance analysis (ANOVA) are excluded from the calculation,
I) determine the potatoes as suitable if the Fmax is at least 12 N above the threshold, and the SA is at least 130 Ns.

The same steps (including those for the determination of the sharpness of the cutting blade) are performed as the previously described texture test to determine proper heating conditions, but now with a predetermined heating step, in order to test the suitability of potatoes as starting material for potato bodies production according to the dried potato body preparation method described herein. For example, potatoes with a floury cooking behaviour are not very well suited to be used as starting material for the method of the present invention. On the other hand, some batches of potato varieties that can be very suitable to be used in the present method, can be less suitable, due to environmental conditions like certain weather conditions during growth of the potatoes, or storage conditions of the potatoes. Therefore, a suitability test is preferably performed before potato bodies according to the present invention are made. Blanching step C) is performed on 1 kg of the potato strings in 26 litre of boiling water. Potato strings from suitable potatoes, determined according to the above-described method, are therefore advantageously blanched for 1 minute in boiling water as a check for the suitability of potatoes for step a) of the preparation method of dried potato bodies presented herein.

Again, the time T_{FP} to reach the first peak on the curve is preferably 14-21 s, more preferably 15-20 s, the time T_{FM} to reach Fmax is preferably 15-24 s, and the Fmax is preferably at least 13 N, more preferably 14 N above the threshold, and the SA is preferably at least 130 Ns.

According to the methods of the invention, the potatoes of step a) preferably have a dry matter content, expressed as specific gravity, of between 1,040 and 1,080 g/ml, preferably between 1,045 and 1,075 g/ml, more preferably between 1,050 and 1,070 and preferably have a value of 1-4 on the 1-7 waxy/floury scale (Ochsenbein et al., J. Texture Studies 41 (2010) 1-16), more preferably of 1-3, even more preferably of 1-2 and most preferably of 1, meaning that suitable potatoes are waxy. The potatoes of step a) preferably originate from a variety, chosen from the group, consisting of Amandine (CVPO19950969, EU2504), Annabelle (CVPO19990634, EU6935), Franceline (CVPO19952868, EU175), Marilyn (CVPO20042380, EU17273), Sunita (EU35905), Panther (EU28545) and varieties derived therefrom. The numbers between brackets refer to corresponding plant breeders rights. It has been shown that by using these varieties, a very attractive potato body product can be produced, with very good firmness and crispiness when used as soup, noodle or sauce application and very good crispiness and brittleness when used as a snack application. It is to be noted that potato varieties for crisps and chips have much more floury characteristics, a higher dry matter content, with a specific gravity of 1,096 or more and are not suitable for the potato body production after the invention due to pronounced softness, lack of crunchiness and granular and starchy texture. For consumable as defined herein, in contrast, potato varieties having lower dry matter content are preferred.

The invention also relates to potato bodies, obtainable by the method as described above, said potato bodies preferably being a snack or component for soup or sauce. Herein, dried potato bodies having a dry matter content of at least 90 w/w % are described that upon rehydration result in crunchy potato pieces. In the art, such potato pieces were not known, potato pieces, dried according to the state of the art methods, are not crunchy upon rehydration.

As described above, low calorie products can be provided by the potato bodies described herein. Such potato bodies preferably have a caloric value of 400 kcal/100 or less, preferably 380 kcal/100 g or less, most preferably 360 kcal/100 g or less, and makes the potato bodies extremely suitable as low calorie snack, such as chips or crisps. The main reason lies in the fact that the potato bodies are preferably not contacted with oil during the preparation process. Chips and crisps known in the art have a caloric value of 530 kcal/100 g. Known light versions of chips have a lower caloric value but still contain ca. 460 kcal/100 g, mainly due to lower fat content that are created by special measures in the production process. Recently oven baked granulated based chips have been introduced with a caloric value of 415 kcal/100 g, still significantly more than the potato bodies as presented herein. To the potato bodies salt and herbs etc. can be added to confer a desired taste to the product.

The invention further relates to a dry soup mix, a dry noodle mix or dry pasta sauce mix, comprising potato bodies as described above. Such a dry mix can be diluted with hot water (i.e. above 50° C., preferably above 60° C., more preferably between 70 and 100° C.) to arrive at a ready-to-use soup or sauce, comprising the potato bodies, that rehydrate when the mix is diluted, resulting in crispy potato bodies in the soup or sauce. When used as an ingredient in soup or in noodle products and formulations, the freeze-dried, potato strings rehydrate quickly after the adding of—and mixing with hot water. The prepared noodles or soup are ready for consumption 2 minutes after adding and mixing of the hot water.

The invention also relates to a method for enrichment of soup or sauce, comprising adding potato bodies to the soup or pasta sauce.

The invention also relates to snack, soup or sauce, comprising potato bodies as described above.

The invention will now be described by way of the following non limiting examples and figures, wherein

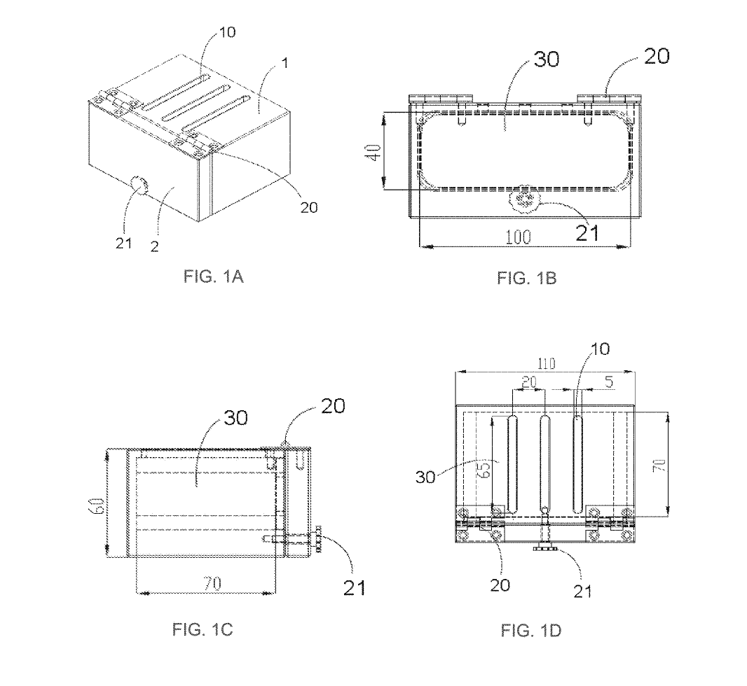

FIGS. 1A-D show different views of a chamber used to perform texture measurements to check whether a batch of potatoes is suitable to be used for the preparation of dried potato bodies or pickled potato strings, or to check whether heating conditions are properly chosen.

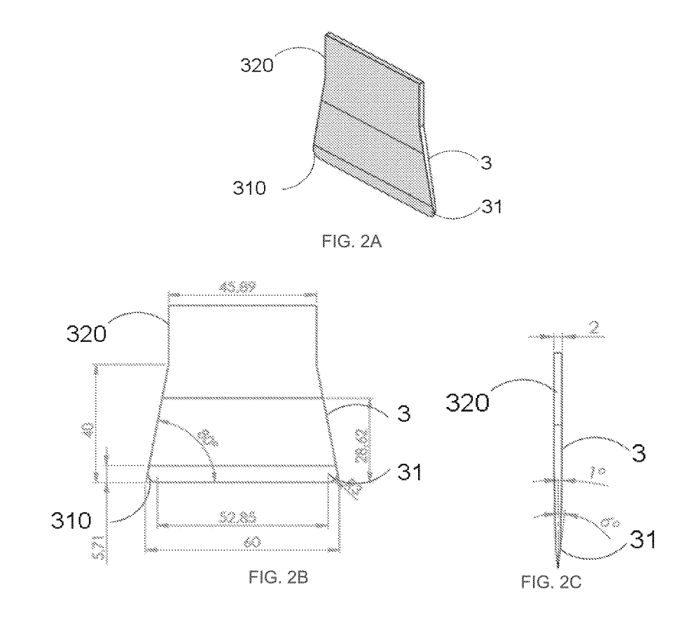

FIGS. 2A-C show a probe blade, used in the said texture measurement.

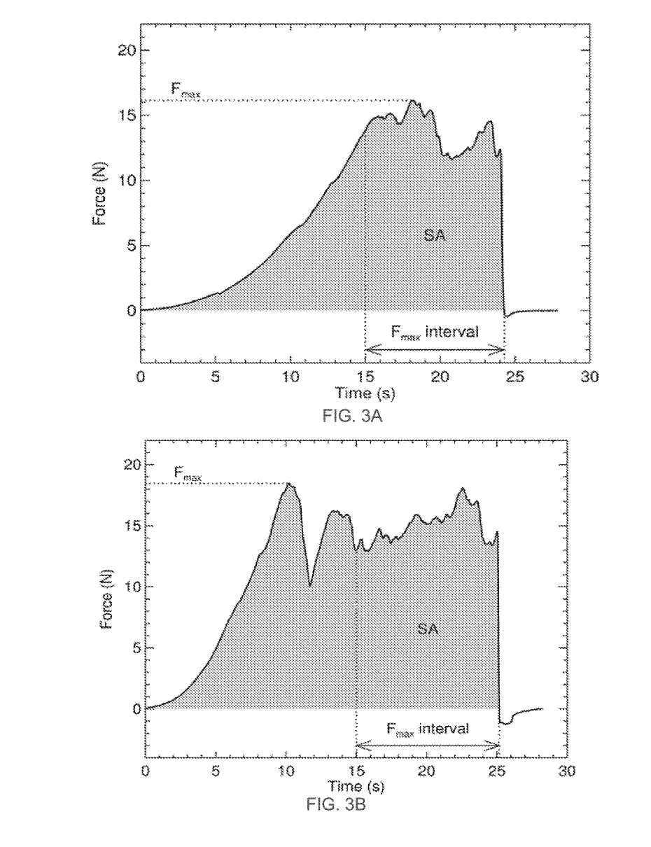

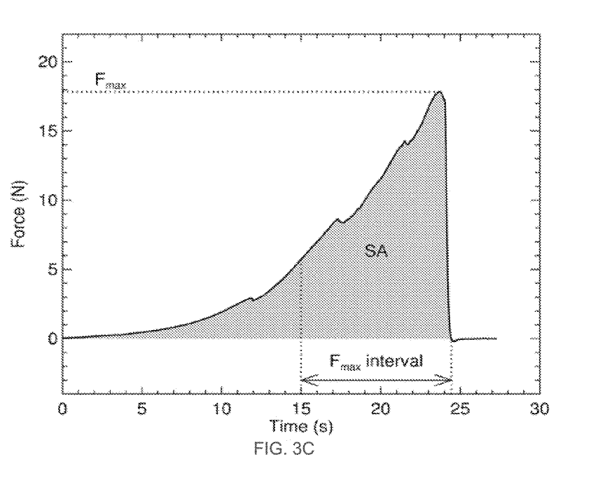

FIGS. 3A-C show graphs of texture measurements on a batch of potato strings of the same variety wherein the force needed to move the probe blade through the heat treated potato strings produced during step c) in the chamber (Y-axis) is shown in time (X-axis) showing examples of inferior and suitable texture profiles that are typical for dried potato products of for tudousi products upon production.

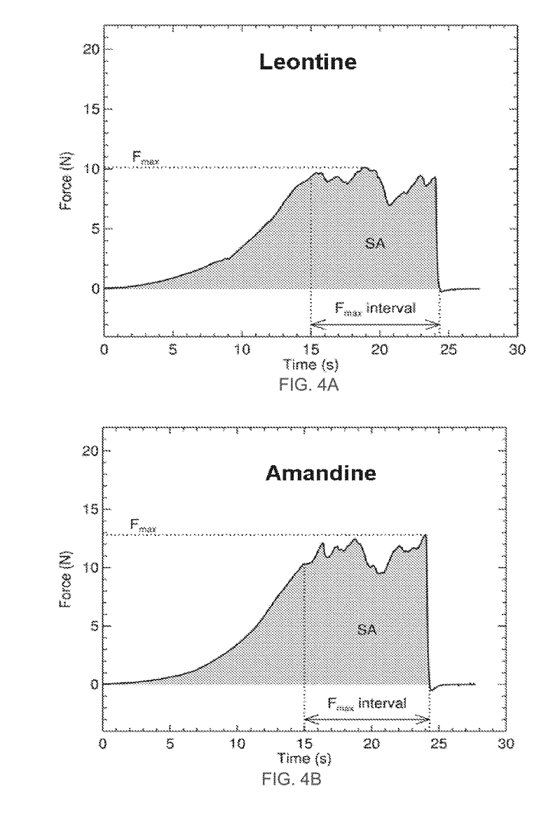

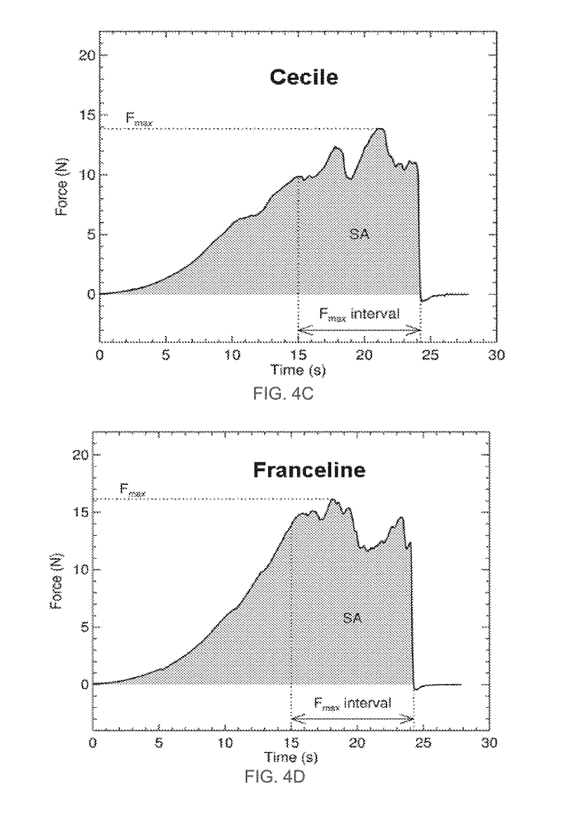

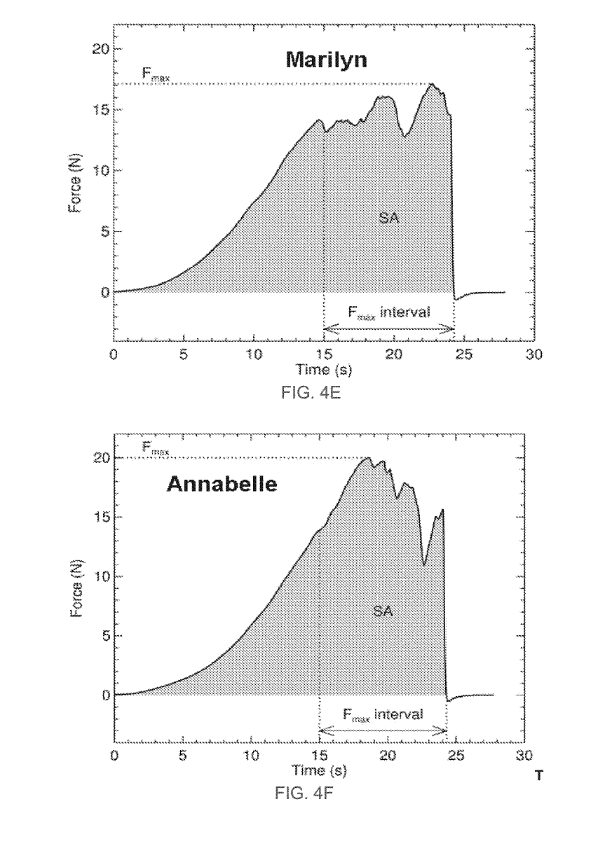

FIGS. 4A-F show graphs of such texture measurements on different potato batches from 6 different potato varieties.

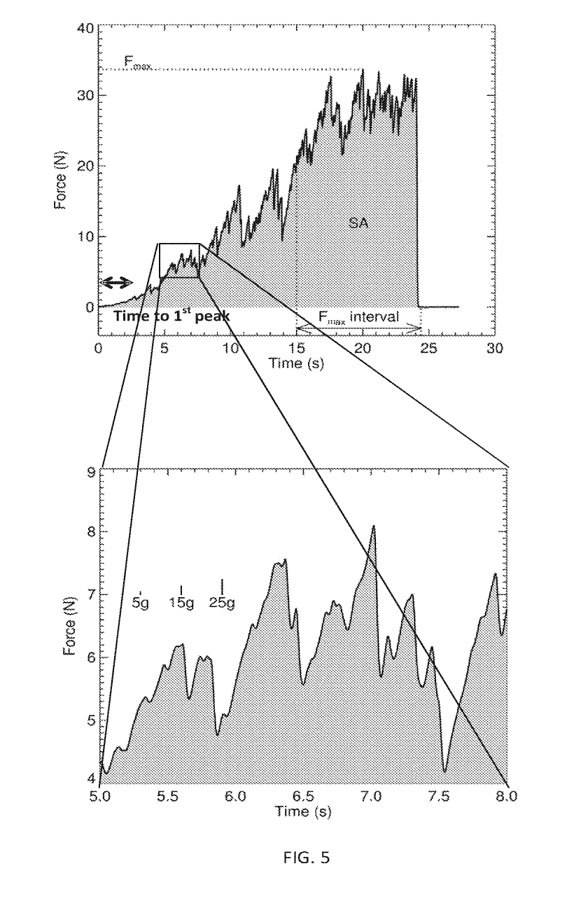

FIG. 5: Texture curves from triplicate runs of freeze-dried potato strings of variety Annabelle, as obtained by the texture protocol described herein. Top panel: Texture curve of a complete run depicting the parameters Fmax, time to 1^{st} peak T_{FP} and area under de curve (SA). The squared section in the top panel is magnified for the visualization of sharp peaks in the ranges 5 to 25 g in the bottom panel. Bottom panel: Magnified section of the top panel depicting sharp peak pattern on top of the texture curve. Scale bars represent peak heights of 5, 15 and 25 g respectively.

FIG. 1A shows housing 1 of a test chamber having a lid 2, with hinges 20, allowing proper opening and closing of the lid 2. Screw cap 21 secures closing of the lid 2. In the housing, three slits 10, arranged in parallel, are present. FIG. 1B shows a cross section, parallel to the lid through the housing with an indication of the dimensions in mm through the test chamber of FIG. 1A, showing screw cap 21 and hinges 20. A cavity 30 for receiving potato strings is depicted by 30. The said cavity has a height of 40 mm and a length of 100 mm. In FIG. 1C, a cross section perpendicular to that of FIG. 1B is shown, again showing hinge 20, screw cap 21 and cavity 30. The width of cavity 30 is 70 mm. FIG. 1D shows a cross section, parallel to slits 10 through the housing, showing screw cap 21 and hinges 20. The slits have a length of 65 mm and a width of 5 mm, and are spaced 20 mm from one another. In use, the lid 2 of the test chamber is opened and 160 gram of potato strings is evenly loaded in the chamber. The lid 2 is closed by turning cap 21. In order to improve the even loading of the potato strings, the chamber can be slightly shaken and knocked on a flat support surface such as a work bench or table.

FIG. 2A shows a drawing of a probe cutting blade showing the front side, defining the length and height of the probe cutting blade and the side, perpendicular thereto defining both the height and the thickness of the probe blade, the probe cutting blade having a lower cutting portion 31, of a blade portion 3 and of an upper mounting portion 320. Side views 2B (from the front) and 2C (from the side), wherein the dimensions are indicated in mm, show the same probe blade having a lower cutting portion 31 having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion 3 rejuvenating over a height of 34 mm to an upper side having a length of 46 mm (i.e. having a rejuvenating angle with the lower sharp edge of 80°), and a thickness at the upper side of 2 mm, adjacent to an upper mounting portion having a constant length of 46 mm and thickness of 2 mm, the thickness of the blade portion 3 rejuvenating from the upper side thereof with an angle of 1° between the front and back side thereof towards the cutting portion, said cutting portion rejuvenating from the upper side thereof an angle of 6° between the front and back side thereof to the lower sharp cutting edge.

The dimensions of the mounting portion are not particularly relevant, as long sufficient surface is provided for a cutting device to hold the probe cutting blade. The cutting edge of sharp cutting portion 31 has a sharpness of 2.08-2.44 N, determined as described above. Such a probe blade is to be used when texture measurements are to be performed according to the present invention.

During a texture measurement, the cavity 30 of the test chamber 1 loaded with a predetermined amount of heated potato strings, and a probe blade as defined above, starting with the sharp edge portion 31 is passed through the slits 10 of the chamber 1 with a predetermined speed for a predetermined time period.

It is known to a skilled person in texture analysis that data generated by texture protocols is not only a function of the product tested but also dependent on the design, dimensions and condition of the instrument, probe and sample container as functional unit for the measurements. Proper and correct use of the texture analyser, probe and sample container combination, good cleaning, regular maintenance and calibrations are basic requirements for the collection of reliable texture data. Small changes in probe and sample container dimensions and specifications, sample quantities or texture analyser settings may change the values of data obtained and let them deviate from the observations in the given examples. Deviations from the given experimental design in terms of dimensions, specifications, quantities and instrumental and software settings, however, may change absolute values of the texture parameters of interest but will not disturb the relative ranking of these texture parameters in the specified texture range of potato bodies or of tudousi products for potato varieties. A skilled person in texture analysis can therefore standardize collected data from a texture analyser, probe, sample container combination that deviates from the described experimental design in this patent to the reference texture values obtained in this patent.

### EXAMPLES 1-5

### Example 1: Texture Measurement Protocol for Potato Strings as Reference for Potato Bodies

Potatoes of an envisaged batch of a potato variety are cut in axial direction to strings of 2.5×2.5 mm, having a length of 30-150 mm with a Halide RG200 vegetable cutter equipped with a 2.5×2.5 mm Julienne knife.

1 Kg of the strings of each variety are blanched in a Frymaster (Frymaster—E4 Electric Fryers RE17TC, 17 kW) with 26 litre of boiling water during 3 minutes. The strings are taken from the boiling water, freed from adherent water on a sieve, and 160 g thereof is immediately evenly loaded in a test chamber as described for FIG. 1, after which the lid of the chamber is closed.

A probe blade as depicted in FIG. 2 is sequentially moved through each of the three slits of the test chamber in the direction to the bottom thereof, with a speed of 1 mm/s over a distance of 2.4 cm. During the movement of the probe blade through the chamber, the resistance force, exerted on the blade is recorded as soon as the said force exceeded a trigger threshold of 0.49N.

The moment when a maximum force Fmax is reached, T_{Fmax,} during the blade movement is recorded as well. To this end, the probe blade is mounted on a Stable Micro Systems TA-X2 Plus texture analyser with associated software (Exponent software version 4.0.9.0, XT Plus Version 0.01178) running in the compression mode at 1 mm/s.

Loading of the potato strings in the test chamber and moving the blade through the test chamber is performed at 60° C. in a Temperature Controlled Peltier Cabinet (XT/PC). This results in three recordings of the resistance force in time.

The above was repeated, resulting in a total 6 recordings per sample of potato strings. Time-force traces of strings samples obtained by the texture analysis protocol with the SMS instrumental design of texture analyser, XT/PC cabinet and probe show typical patterns as shown in FIGS. 3A-C, in this case for the variety Franceline. More than 90% of all curves obtained with the experimental design has the shape and pattern of FIG. 3A. An initial gradient in force between 0 and 15 seconds leads to a series of force peaks in the time frame between approximately 15 and 25 seconds. The gradient can be explained by a steady compression of the product by the probe until the product is fully trapped between the knife and the bottom of the container at about 15 seconds runtime. Then the knife starts cutting the strings that are encountered during the remaining runtime with typical spikes as result. The height of the force and associated parameters depend on the texture of the sample and will get further attention in examples 2 and onwards.

The time-force curves are interpreted by SMS software and a defined macro (see table 1) for this purpose into 4 descriptive texture parameters Fmax (the highest peak in the curve), the time to the first peak (T_{FP}), the time to Fmax (T_{Fmax}) and the surface area under the curve SA as measure for labour conducted during the run.

Despite the care taken during the filling of the container, uneven filling may occur within certain spaces of the container with too high or too low density of strings per unit volume as result. Above average density of strings may lead to curve shapes that differ from those with under average density. The texture analysis protocol therefore preferably comprises a quality control step to remove outlier curves from the 6 texture recordings per sample applying ANOVA analysis as QC tool for the interpretation and classification of the samples for potato body quality criteria. Analysis of variance (ANOVA using GenStat 14^{th} Edition software) on the data of the texture parameters from 6 time-force curves per sample, as a tool for quality control of collected data, reveals that a small number of curves yields aberrant texture data that significantly deviate from the mean values of the 6 observations at p=0.05 (95% confidence interval, 95% CI). The application of a one-factor ANOVA, as classical variance test, with variety as factor and the texture parameters Fmax or SA typically identifies outliers in the 6 observations per parameter outside the 95% CI according to the ratio between deviations of individual data values from the average (calculated as residues from the average) divided by 2×√(residual variance) from the ANOVA analysis table. Absolute ratio's =/>2 are outside the 95% CI, marked as outliers and removed from the data file prior to the calculation of average Fmax (the highest peak in the curve), the time to the first peak (T_{FP}), the time to Fmax (T_{Fmax}) and the surface area under the curve SA values per sample. Root cause analysis resulted in the observation that the outlier data for the texture parameters were mainly originating from a curve shape with a low and late gradient in combination with a late first peak in the curve almost at the end of the runtime, between 24 and 25 s (FIG. 3C). In a number of cases a curve (FIG. 3B) with a steep force gradient and an early first peak earlier than 14 s is observed, leading to high SA type outliers. When measurement results as shown in FIGS. 3B and 3C are obtained, these measurements should not be included in the texture analysis. FIG. 3A shows a proper measurement, wherein the first peak is within the proper interval of 14-21 s.

TABLE 1
Software macro settings for time-force curve
interpretation in terms of Fmax, T_{FP}, T_{Fmax,} and SA.
Program

| | | | | | | | | |
|---|---|---|---|---|---|---|---|---|
| | | unit/ | | | | | | texture |
| step | setting | mode | R | F | ? | A | I | trait |

| | | | | |
|---|---|---|---|---|
| Clear Graph Results | | | | |
| Redraw | | | | |
| Search Forwards | | | | |
| Go to Peak +ve Value | Force | | | |
| Set Threshold . . . Force | 25 | g | | |
| Mark Value Time | | | X | T_{fp} (s) |
| Go to . . . Time | 0 | sec | | |
| Go to Abs. +ve Value | Force | N | | |
| Mark Value Force | | | X | Fmax |
| | | | | (N) |

[symbol]

[symbol]

indicates data missing or illegible when filed

Significant differences for the texture parameters Fmax, T_{FP}, T_{Fmax} and SA are calculated with variance analysis (ANOVA) and expressed as LSD (Least Significant Difference) values at p=0.05 and presented below data tables if applicable. If data of more than 2, preferably more than 1 of the measurements have to be discarded according to the ANOVA analysis, the conclusion must be drawn that the packing of the potato string sample or samples was not evenly, and that sampling and measurements are to be repeated. In an exceptional case where despite even packing more than two measurements, preferably more than one of the measurements are to be discarded, the strings batch is outside specifications in that it contains a heterogeneous mix of strings that do not meet the quality criteria.

### Example 2: Suitability Test of Potato Samples for Potato Body Applications

For a producer of crunchy potato bodies, it is important to be able to assess whether or not envisaged potatoes are suitable to be used as starting material for the said potato bodies or not. Performing the texture analysis of the present invention will provide an objective indicator for the suitability of a lot of ware potatoes from a certain variety for this purpose. The indicator has a good predictive power to ascertain that the ware potato lot concerned indeed will deliver a crunchy potato body grade product at the end of the production process.

Potatoes of the varieties Amandine (EU2504), Annabelle (EU6935), Franceline (EU175), Marilyn (EU17273), Cecile (EU14664), Charlotte (NL005990), Leontine (EU21350) and Gourmandine (EU8902), the numbers between brackets referring to corresponding plant breeders rights as indicated above, were peeled and cut in axial direction to strings of 2.5×2.5 mm, having a length of 30-150 mm with a Halide RG200 vegetable cutter equipped with a 2.5×2.5 mm Julienne knife. Upon cutting the strings were washed twice in excess water (weight-water ratio 4) for the removal of starch granules that were liberated in the cutting process.

1 Kg of water washed strings of each variety were blanched in a Frymaster (Frymaster—E4 Electric Fryers RE17TC, 17 kW) with 26 litre of boiling water during 3 minutes. This preparation protocol represents quality control production circumstances to study if ware potato lot is suited for the production of crunchy potato bodies for the envisioned use. After blanching, the potato string samples were taken from the boiling water, freed from adherent water on a sieve, and measured for texture using the texture protocol of example 1. Force-time curves of single measurements of the samples, as measured with the texture analyser protocol, from 6 of the 8 varieties covering the texture range are shown in FIGS. 4A-F. The variety names of these examples are depicted in the figures. The time-force curves of the varieties show quite similar patterns to the first peak and peak time T_{FP} in the curve in the 14-21 seconds range and the positioning of Fmax values in the 15-24 s time interval. Table 2 gives an overview of the average Fmax, T_{FP}, T_{Fmax} and SA values of the 8 varieties after quality control by ANOVA.

TABLE 2
Predictive quality control protocol for crunchy potato body suitability
expressed as average parameter values of n = 6 measurements

| | Specific gravity | Fmax | T_{FP} | T_{Fmax} | SA |
|---|---|---|---|---|---|
| Variety | (g/ml) | (N) | (s) | (s) | (Ns) |
| Amandine | 1.070 | 12.0 | 18.1 | 23.0 | 141.0 |
| Annabelle | 1.070 | 15.2 | 18.6 | 20.1 | 178.2 |
| Cecile | 1.078 | 11.3 | 16.2 | 21.0 | 156.0 |
| Charlotte | 1.081 | 9.7 | 15.3 | 19.7 | 127.1 |
| Franceline | 1.075 | 12.0 | 19.1 | 22.5 | 146.3 |
| Gourmandine | 1.078 | 9.7 | 14.7 | 21.6 | 132.0 |
| Leontine | 1.076 | 8.5 | 14.9 | 19.4 | 115.8 |
| Marilyn | 1.070 | 14.1 | 18.4 | 22.9 | 175.4 |
| LSD p = 0.05 | | 1.7 | 3.0 | 3.1 | 32.6 |

According to the texture protocol, the varieties Amandine, Annabelle, Franceline and Marilyn have an average Fmax of 12 N or more, and an average SA of above 130 Ns, indicating that these varieties, at least the tested batches thereof, have a high level of firmness according to the texture measurements and are suitable to be used in the method of the invention to prepare crunchy potato bodies.

### Example 3: Sensorial Quality and Texture of Crunchy Potato Bodies

Potatoes of the above-described varieties Amandine, Annabelle, Franceline, Leontine, Marilyn and of the varieties Agria (NL7603), Fontane (EU6748) and Challenger (EU20951) were peeled, cut into strings washed and blanched as in example 2, blast chilled to −20° C. in 8 minutes using a Hobart Foster BCF21 blast chiller, freeze dried with a Labconco freeze dryer equipped with a sample chamber with heated shelves programmed at 35° C. in 24 hours to 99.8% dry matter and subsequently packed in sealed PE bags in portions of 250 g under protective atmosphere and stored at room temperature in darkness until use.

A) Soup
Portions of 5 g of the freeze dried strings from each of the varieties were put in a cup of hot beef bouillon soup (Cup-a-Soup®, Unilever, Netherlands), prepared according to the recommendations of the manufacturer) whereafter the soup was further stirred for another two minutes.

B) Snack
Portions of 20 g of freeze dried potato strings were tested as snack by consuming the strings without further processing.

Both soup and snack samples were evaluated on 6 product related attributes per application and overall impression See tables 3A and 3B.

Soup related potato body attributes were (1) crunchiness perceived as texture, (2) crunchiness perceived as sound, (3) crunchiness upon 30 minutes op standing time, (4) firmness, (5) granularity and (6) starchiness. Both crunchiness as texture and sound attribute was scored on a yes/no scale, Crunchiness upon 30 minutes standing time was scored as high or absent. Firmness was scored on a high to low scale. Granularity and starchiness on a no to high level scale.

Snack related potato body attributes were (1) crunchiness perceived as texture and (2) sound, (3) the main texture attribute upon chewing, (4) the texture experience before swallowing, (5) clearance from the mouth and (6) the texture attribute as aftertaste. Both crunchiness as texture and sound attribute were scored on a high to low scale, attributes 3 and 4 were scored in applicable wording, clearance in the mouth was scored on a slow to fast scale, texture aftertaste in appropriate wording.

To this end, an in house 5 member expert panel from HZPC Holland BV was previously trained in 3 consecutive days for the consistent scoring of the 6 attributes using the potato products with wide expression ranges for the attributes of interest. The trained panel was ultimately appraising both soup and snack samples from the 7 varieties in a random order in duplicate according to best sensorial practice (blind, coded, uniform light, on the described attribute scales).

TABLE 3A
Sensorial evaluation of potato bodies in soup

| | crunchiness | crunchiness | crunchiness | | | | overall |
|---|---|---|---|---|---|---|---|
| variety | (texture) | (sound) | 30 minutes | firmness | granularity | starchy | impression |
| Amandine | yes | yes | high | high | no | no | good texture |
| Annabelle | yes | yes | high | high | no | no | good texture |
| Franceline | yes | yes | high | high | no | no | good texture |
| Marilyn | yes | yes | high | high | no | no | good texture |
| Leontine | no | no | absent | medium | medium | medium | poor texture |
| Agria | no | no | absent | low | high | high | poor texture |
| Fontane | no | no | absent | low | high | high | poor texture |
| Challenger | no | no | absent | medium | high | high | poor texture |

TABLE 3B
Sensorial evaluation of potato bodies as snack

| | | | main | | | | |
|---|---|---|---|---|---|---|---|
| | | | texture | | | | |
| | crunchiness | crunchiness | upon | chewing | clearance | texture | overall |
| variety | (texture) | (sound) | chewing | experience | in mouth | aftertaste | impression |
| Amandine | high | high | melting | juicy | fast | none | good |
| | | | | | | | texture |
| Annabelle | high | high | melting | juicy | fast | none | good |
| | | | | | | | texture |
| Franceline | high | high | melting | juicy | fast | none | good |
| | | | | | | | texture |
| Marilyn | high | high | melting | juicy | fast | none | good |
| | | | | | | | texture |
| Leontine | medium-low | medium | mealy | starchy | rather slow | gluey | poor |
| | | | | | | | texture |
| Agria | medium | medium | granular | starchy | slow | sticky | very poor |

It can clearly be seen that in particular the varieties Annabelle, Franceline and Marilyn are high in the level of perceived firmness and crunchiness, when added to soup as ingredient. Crunchiness of the potato bodies is perceived as texture and sound upon preparation and is maintained up to 30 minutes after preparation time. The potato bodies after the invention do not show any granularity and starchiness.

The sensory attributes of potato bodies of the invention, represented by the samples from Amandine, Annabelle, Franceline and Marilyn, can as snack best be described as a combination of crunchy, in terms of texture and sound, melting upon chewing, juicy due to saliva stimulation and with fast clearance from the mouth.

These texture features were also true when the potato bodies had a strip shape having a width of 6 mm, a thickness of 2.5 mm and a length of 20-40 mm. (data not shown) and happen to be independent from the various potato body dimensions described in this invention.

Also, snacks in the form of potato bodies having a disc shape and a thickness of 2 mm and a diameter of 5-6 mm resulted in similar results.

### Example 4: Determination of the Proper Heating Conditions

Strings as prepared above from the varieties Franceline and Leontine were heated in six different ways.

1: batch-wise blanching as described in example 1 for 1 minute

2: batch-wise blanching as described in example 3 for 3 minutes

3 batch-wise blanching for 5 minutes

4: continuous blanching at 90° C.

5: continuous blanching at 95° C.

6: continuous blanching at 99° C.

Table 4 describes the conditions of the 3 batch-wise processes and 3 continuous production processes for potato strings for the varieties Franceline and Leontine as described in example 2 at increasing heating intensities for the batch process (1 to 5 min blanching time) and the continuous process (blanching with water and steam at temperatures from 90 to 99° C.). These treatments are designed for the identification of the optimal heating time for the envisaged potato body products according to batch and continuous production principles.

TABLE 4
Process parameters in a batch and continuous production process of potato strings
critical process parameters

| | | | | | | | | | | primary | | | | | |
|---|---|---|---|---|---|---|---|---|---|---|---|---|---|---|---|
| | | | | | | | | | | steam/water | | additional | | | |
| nr | process | treatment | medium | temperature | | quantity strings | | energy input | | input | | water input | | total volume | |
| 1 | batch | 1 min blanching | water | 100° | C. | 1 | kg/batch | 17 | kW | 26 | kg | 2 | kg/hr | 26 | l |
| 2 | batch | 3 min blanching | water | 100° | C. | 1 | kg/batch | 17 | kW | 26 | kg | 2 | kg/hr | 26 | l |
| 3 | batch | 5 min blanching | water | 100° | C. | 1 | kg/batch | 17 | kW | 26 | kg | 2 | kg/hr | 26 | l |
| 4 | continuous | 3 min blanching | water & steam | 90° | C. | 1500 | kg/hr | 101 | kW | 150 | kg/hr | 70 | l/hr | 220 | l/hr |
| 5 | continuous | 3 min blanching | water & steam | 95° | C. | 1500 | kg/hr | 105 | kW | 160 | kg/hr | 60 | l/hr | 220 | l/hr |
| 6 | continuous | 3 min blanching | water & steam | 99° | C. | 1500 | kg/hr | 112 | kW | 170 | kg/hr | 50 | l/hr | 220 | l/hr |

Texture measurements as described in example 1 were performed on the strings samples produced by the 6 different treatments and data obtained are summarized in table 5.

TABLE 5
Texture parameters of Franceline and Leontine strings in
a batch and continuous production process after table 4 expressed
as average parameter values of n = 6 measurements

| | Franceline | | | | Leontine | | | |
|---|---|---|---|---|---|---|---|---|
| process | Fmax | T_{fp} | T_{Fmax} | SA | Fmax | T_{fp} | T_{Fmax} | SA |
| nr | (N) | (s) | (s) | (Ns) | (N) | (s) | (s) | (Ns) |
| 1 | 15.3 | 17.1 | 21.4 | 152.4 | 12.5 | 16.0 | 19.5 | 129.7 |
| 2 | 15.2 | 17.4 | 21.6 | 150.9 | 10.5 | 15.5 | 19.6 | 117.8 |
| 3 | 12.1 | 15.9 | 21.3 | 130.0 | 8.5 | 15.2 | 19.4 | 95.8 |
| 4 | 15.6 | 16.9 | 21.4 | 154.7 | 12.7 | 15.9 | 19.7 | 130.1 |
| 5 | 15.3 | 17.2 | 21.5 | 151.9 | 9.9 | 15.6 | 19.3 | 116.8 |
| 6 | 12.2 | 15.8 | 20.9 | 127.8 | 8.3 | 15.3 | 19.4 | 97.4 |
| LSD | 1.7 | 3.0 | 3.1 | 32.6 | 1.7 | 3.0 | 3.1 | 32.6 |
| p = 0.05 | | | | | | | | |

The texture data from table 5 indicate that the texture parameters Fmax and SA decrease as a function of blanching time in the batch treatments 1-3 and the continuous process treatments 4-6 for both varieties. The decline is more pronounced for the variety Leontine than for Franceline in line with the (lack of) suitability of these varieties for the potato body product as presented herein. For Franceline, the processing window from blanching perspective is preferably between 1 and 3 minutes in the batch process, although 5 minutes also results in texture values within the desired range. For the continuous process, the preferred window comprises 90 and 95° C. under the given conditions, whereas at 99° C. the SA value becomes a bit low. This indicates that blanching time and blanching temperature settings can be optimized when preparing the potato bodies. Over-processing may lead to loss of texture in suitable varieties like Franceline.

### Example 5: Texture Characteristics of Freeze-Dried Potato Strings Before and After Reconstitution in Hot Water

Freeze-dried potato strings of 2.5×2.5 mm from a range of 16 varieties were produced according to the method of example 3 and subsequently evaluated for texture profiles by a 5 member sensory panel with attention to the texture attributes crunchy, hard, dry and floury, identified as the most pronounced texture traits of freeze-dried potato strings in preliminary profiling sessions. The attributes were scored on a 1-9 point category scale denoting low to high expression for the attributes in the studied sample range. Panel members evaluated 20 g samples for each of the varieties blindly (coded products) in replicate and randomized order, according to best practice principles for sensory profiling. Results of these sensory sessions with the 16 samples are presented in table 6 as average scores for the attributes.

Texture attributes show wide and significant variation for the studied varieties (ANOVA, p<0.05 for the attributes, data not shown). Crunchy and hard are significantly correlated (r²>0.70, p<0.05), hard samples are more crunchy. Crunchy and hard are inversely related to floury, meaning that samples with low levels of hard and crunchy show floury characteristics. Annabelle, Cecile, Marilyn, Panther (EU28545) and Sunita (EU35905) are varieties with high crunchy/low floury scores.

TABLE 6
Texture attributes of freeze-dried potato
string samples from 16 varieties

| Variety | Crunchy | Hard | Dry | Floury |
|---|---|---|---|---|
| Annabelle | 7.5 | 8.7 | 5.7 | 3.0 |
| Asterix | 5.0 | 4.0 | 5.0 | 6.0 |
| Cecile | 8.3 | 7.3 | 6.0 | 3.3 |
| Challenger | 6.3 | 5.8 | 5.7 | 6.3 |
| Colomba | 5.3 | 5.0 | 6.0 | 4.5 |
| Farida | 5.7 | 5.3 | 4.7 | 6.0 |
| Ivory Russet | 6.3 | 4.0 | 5.5 | 4.5 |
| Leonardo | 3.0 | 3.5 | 6.8 | 6.2 |
| Lucinda | 6.3 | 5.5 | 6.0 | 5.7 |
| Marilyn | 8.2 | 7.7 | 6.0 | 4.1 |
| Panther | 7.3 | 7.3 | 2.3 | 2.5 |
| Sifra | 5.8 | 4.5 | 4.5 | 4.0 |
| Spunta | 5.3 | 5.2 | 7.3 | 7.0 |
| Sunita | 7.8 | 7.0 | 4.0 | 3.0 |
| Talentine | 4.0 | 4.5 | 5.8 | 5.7 |
| Voyager | 5.5 | 5.5 | 7.5 | 6.0 |

The freeze-dried samples were also subjected to texture analysis applying a texture analyzer protocol. Texture of 20 g freeze-dried strings were subjected to the texture protocol of example 1 at similar instrumental and software settings at room temperature. Twenty gram dried samples occupy a similar volume in the test cell as 160 g blanched strings. Application of the texture protocol results in typical texture curves as depicted in FIG. 5.

The curves show typical bending and breaking characteristics represented by a steady increase in force, area under the curve, and most typically, sharp peaks in the range of 5 to 25 g on top of the curves. These sharp peaks represent the forces that are associated to the breaking of strips during the texture analysis process. The texture curves allow the measurement of the texture parameters Fmax, area, gradient, time to first peak T_{FP} and the count of peaks of 5 g, 15 g and 25 g. These texture parameters were measured and subsequently calculated with a macro (in analogy to table 1) during 2 runs (in triplicate) yielding 6 curves and derived texture parameter values per potato sample. Results (averages obtained of 6 curves per sample) are presented in table 7. The varieties show significant variation for the measured traits (ANOVA, data not shown) and can be put into different texture classes based on the combination of texture parameters. When instrumental texture parameters of the freeze-dried potato string samples are associated to the corresponding sensorial attribute scores of table 6, clear relationships are noticed with the best model between floury and the instrumental parameters. Partial least squares analysis (Unscrambler software, Camo, Norway) using the instrumental texture parameters as predictive x variables and sensory attributes as y-variables result in significant models (r²=60%) with the parameters Fmax, count peaks 5 g, T_{FP} and gradient as influential parameters. Crunchy/hard and floury levels are determined by these 4 parameters that jointly stimulate the expression of crunchy and hard and limit or decrease floury. High Fmax values in combination with high counts of 5 g peaks, long time to first peak and steeper gradients lead to a crunchy, non-floury freeze-dried potato strings. The relative contribution to the crunchy trait is according to the following ratio's:Fmax:peak count 5 g:T_{FP}:gradient=0.22:0.26:1.10:0.31. The texture protocol can be applied to check crunchiness of freeze- dried potato bodies based on multivariate principles.

The sensorial characteristics of freeze-dried potato strings were also evaluated upon rehydration in hot water as another preferred embodiment of the invention. Strings (5 grams) were put in hot water (60° C.) and were allowed to dehydrate for a period of 5 minutes. Rehydrating strings were stirred after 2.5 and 5 minutes during this rehydration process. Strings were subsequently profiled for the attributes crunchy, hard, floury and chewy by a 5 member trained panel as described previously using similar 1-9 point scales for the attributes. Results of these sensory sessions of 16 samples are presented in table 8 as average scores for the attributes. The varieties have different texture profiles after rehydration in comparison to freeze-dried samples. Where for freeze-dried samples up to 8 samples had a crunchy score above 6, only 2 rehydrated samples realized this level (Annabelle and Marilyn). Rehydration of freeze-dried potato strings into a crunchy rehydrated product apparently is a demanding process from textural perspective. Only Marilyn and Annabelle meet these requirements in the list of studied samples like they also did for freshly produced potato strings. These varieties have the unique intrinsic quality to deliver crunchy potato strings in a range of production conditions.

TABLE 7
instrumental texture parameters of freeze-dried potato strings

| | | Count | Count | Count | | | |
|---|---|---|---|---|---|---|---|
| | | Peaks | Peaks | Peaks | | | |
| | Force | 5 g | 10 g | 25 g | Area | Gradient | T_{FP} |
| Variety | N | g | g | g | N · s | N/s | s |
| Annabelle | 31.0 | 126.8 | 105.2 | 93.0 | 326.6 | 0.8 | 3.2 |
| Asterix | 30.3 | 110.2 | 89.8 | 79.3 | 311.2 | 0.5 | 1.9 |
| Cecile | 29.6 | 113.6 | 93.9 | 82.0 | 312.2 | 0.9 | 3.1 |
| Challenger | 22.8 | 110.0 | 87.3 | 75.7 | 199.6 | 0.4 | 3.0 |
| Colomba | 30.1 | 125.5 | 103.7 | 91.7 | 359.5 | 1.0 | 2.4 |
| Farida | 28.6 | 129.0 | 107.7 | 94.2 | 333.0 | 1.1 | 1.5 |
| IvoryRusset | 17.3 | 116.3 | 87.5 | 66.4 | 153.5 | 0.4 | 2.6 |
| Leonardo | 26.2 | 103.5 | 80.1 | 67.3 | 268.6 | 0.5 | 2.7 |
| Lucinda | 30.5 | 119.5 | 96.4 | 82.7 | 320.4 | 0.7 | 2.7 |
| Marilyn | 35.4 | 119.3 | 102.2 | 89.7 | 355.3 | 0.5 | 1.7 |
| Panther | 31.0 | 114.0 | 91.3 | 80.0 | 299.0 | 0.7 | 3.1 |
| Sifra | 29.6 | 126.6 | 102.1 | 88.3 | 283.7 | 0.8 | 2.6 |
| Spunta | 21.8 | 122.4 | 100.0 | 83.5 | 236.2 | 0.7 | 2.3 |
| Sunita | 28.7 | 118.3 | 94.9 | 80.3 | 251.6 | 0.6 | 2.8 |
| Talentine | 30.5 | 114.1 | 99.2 | 89.5 | 322.8 | 0.5 | 2.3 |
| Voyager | 30.4 | 111.3 | 92.9 | 82.8 | 274.2 | 0.6 | 2.5 |

The instrumental texture parameters of the freeze-dried potato string samples are also associated to the corresponding sensorial attribute scores of table 8 and clear relationships are noticed with the best model between floury and the instrumental parameters. Partial least squares analysis (Unscrambler software, Camo, Norway) using the instrumental texture parameters as predictive×variables and sensory attributes as y-variables result in significant models (r²=74%) with the parameters Fmax, count peaks 5 g, count peaks 10 g and gradient as influential parameters. Crunchy/hard and floury levels are determined by these 4 parameters that jointly stimulate the expression of crunchy and hard and limit or decrease floury. High Fmax values in combination with high counts of 5 g peaks, high counts of 10 g peaks and low gradients lead to a crunchy, non-floury rehydrated freeze-dried potato strings. The relative contribution to the crunchy trait is according to the following ratio's:Fmax:peak count 5 g:peak count 10 g:gradient=0.58:0.74:0.54:−0.60.

The texture protocol can be applied to check crunchiness of rehydrated freeze-dried potato bodies based on multivariate principles.

TABLE 8
Texture attributes of rehydrated freeze-dried
potato string samples from 16 varieties

| | Crunchy | Hard | Floury | Chewy |
|---|---|---|---|---|
| Variety | RH | RH | RH | RH |
| Annabelle | 7.0 | 6.7 | 2.0 | 5.2 |
| Asterix | 4.5 | 3.5 | 4.5 | 4.5 |
| Cecile | 5.0 | 4.0 | 5.5 | 4.7 |
| Challenger | 3.2 | 3.3 | 6.8 | 4.0 |
| Colomba | 3.0 | 3.0 | 3.5 | 3.5 |
| Farida | 4.3 | 3.7 | 3.5 | 3.3 |
| Ivory Russet | 2.5 | 2.5 | 5.5 | 4.0 |
| Leonardo | 4.0 | 2.7 | 6.5 | 4.0 |
| Lucinda | 5.3 | 3.8 | 3.8 | 5.0 |
| Marilyn | 6.7 | 5.5 | 2.0 | 2.3 |
| Panther | 5.5 | 5.2 | 2.7 | 3.3 |
| Sifra | 3.3 | 3.0 | 3.5 | 4.0 |
| Spunta | 5.7 | 6.3 | 3.3 | 4.5 |
| Sunita | 5.5 | 5.5 | 3.0 | 3.0 |
| Talentine | 3.2 | 3.2 | 3.7 | 2.5 |
| Voyager | 3.8 | 4.0 | 4.5 | 5.5 |

The texture results obtained from sensorial and instrumental screenings on freeze-dried and rehydrated freeze-dried potato strings show that crunchy non-floury texture can processed, noticed and objectively measured with sensorial and instrumental protocols according to defined and desired norms and criteria. Annabelle and Marilyn show crunchy/non-floury characteristics in both products.

In another aspect, the invention relates to a method for the preparation of pickled potato strings, also known as tudousi, used in the oriental kitchen.

At present, tudousi is prepared for direct consumption by stir-frying freshly prepared, often hand-cut potato strings in portions that meet the daily requirements. These prepared strings have a small cross sectional area of 25 mm² or less and in general do not have a shelf life. Tudousi can only be kept in the refrigerator for about a day because of quick discoloration (by loss of native colour and/or after-cooking darkening) and development of off-flavours. Longer storage also often results in strings with soft and mealy texture that become a soft, granular and decomposing product upon stir-frying, instead of being intact strings with a bite and crispiness. The reason for the loss of texture and structure of the prepared potato strings is believed to be related to ongoing oxidation based deterioration processes in texture and structure upon preparation and associated to the intensity of the cooking process, the relatively small cross-sectional area of the potato strings, a large surface to volume ratio in the product, and a relatively high water loss. For this reason, only prepared potato strings having a relatively large cross sectional area of 40 mm² or more, also known as French fries, can be kept for more than a day in the refrigerator without losing texture significantly. Potato strings appear to have no shelf life whatsoever because of rapid, enzymatic deterioration and oxidation processes in the product.

In the art another conservation method is known, wherein food is incubated in an acid liquid, also known as “pickling”. Thus treated foods are known as “pickled” food and do not need refrigeration or to a lesser extent as compared to similar non-pickled food. Such acid conditions can also be generated by incubation of the food in a brine solution, allowing anaerobic fermentation to take place, i.e. by Leuconostoc mesenteroides and/or Lactobacillus plantarum resulting in an acid pickling liquid. However, pickled potato products are only known in limited occasions. Pickling of potatoes namely has several drawbacks. Potatoes are, relative to other vegetables used for pickling, dense in dry matter and structure and the pickling liquid cannot reach the kernels of the tubers during the pickling process. For that reason, pickling is only applied to tubers with a small diameter, cut potato cubes and potato slices. In said process of pickling, tubers are cooked, in order to disintegrate the cell walls, thus allowing the diffusion of the pickling solution into the potatoes, cubes or slices. However, cooked potatoes tend to go mush during incubation in a pickling solution, as the integrity has largely been lost as a result of said cooking.

In the art, there is no method available for the preparation of pickled potato strings having a small cross sectional area of 25 mm² or less that are still crunchy, i.e. without significantly becoming mush in particular after storage.

From a recipe from food.com (http://www.food.com/recipe/tu-dou-si-chinese-style-potatoes-508669) the preparation of tudousi with a buttery taste is known. To this end, potato strings are soaked in vinegar for 20 minutes and stir fried in oil. Said tudousi is intended for direct consumption and will lose crunchiness upon storage.

This invention describes the production process of pickled potato strings, while surprisingly maintaining its crunchiness upon storage, comprising the heating of freshly cut potato strings having a small cross sectional area of 25 mm² or less and flash cooling, i.e. blast chilling the heated strings, followed by incubation in a liquid pickling medium. These potato strings have an extended shelf life as known for other pickled food products (i.e. up to over several years at ambient temperature) keeping its original texture and can be stir fried after being stored resulting in a stir fried potato product (tudousi), having texture and bite comparable with and not discernible from a stir fried potato product from freshly cut potato strings. Said pickled potato strings are particularly suitable for dishes with strong flavours.

To this end, the invention relates to a method for the preparation of pickled potato strings, comprising the steps of:
a) Providing potatoes,
b) Cutting the potatoes of step a) in strings having a cross-sectional area of 25 mm² or less,
c) Heating the potato strings of step b) to a temperature of 140° C. or less,
d) Blast chilling the heated potato strings of step c) to 10° C. or less,
e) Incubating the blast chilled potato strings of step d) in a liquid pickling medium having a pH between 3 and 4.5 at an elevated temperature of at least 65° C.

The potatoes are preferably peeled before or during the cutting step b). Peeling of the potatoes can e.g. be performed and automated with any knife or abrasive based peeler at room temperature, but preferably not by heat operated peelers, to avoid heat pre-treatment on the tubers during the production process prior to the cutting of potato strings. It is also possible however to provide the potatoes unpeeled, but preferably at least washed.

Cutting of the potato strings can be performed by any suitable device and can be automated. Although the cross sectional area of the potato strings can have any form, such as round, rectangular or irregular, a square form is preferred as this form minimizes losses in cutting of the potatoes. A cross-sectional area of 25 mm² or less clearly discriminates the strings from any known potato product such as French fries.

Preferably, the cut potato strings are washed, to remove excess of starch.

The cut potato strings are heated as pre-treatment. Preferably after washing. Without such, preferably immediate, heating step, i.e. in case cut potato strings are kept refrigerated without heating pre-treatment, stir frying such refrigerated strings does result in an inferior product with poor texture and appearance. The strings will deteriorate fast in terms of colour, texture and flavour due to triggered oxidation processes upon cutting and deterioration of the cell walls.

Heating can take place e.g. by blanching the potato strings in boiling water, or by steaming at a higher temperature, or by any other suitable heating method known in the art. The term ‘blanching’ is intended to mean the heating of the potato strings with hot water or steam to obtain a product with optimal colour, taste, texture and appearance upon packaging and storage during their shelf life period. To this end it is important that the potato strings, having the right dimensions as defined herein, are brought in a sufficient volume of hot water or steam so that optimal heat exchange between the potato strings and the hot water can take place. The higher the heating temperature, the shorter the heating is usually to be performed. For example, if blanching in boiling water is chosen as heating method, the heating time may e.g. vary between 30 seconds and 4 minutes, which can be determined by the skilled person. When the strings are heated by steam of e.g. 120° C., the heating time will be less, e.g. 15 seconds to one minute. The minimum temperature for effective blanching is preferably 60° C., more preferably 70° C., even more preferably 80° C. and typically the minimum temperature is in the range of 80-90° C. for a product with good texture, shelf life and microbiological specifications. It has however been found that the dry matter content of the potato strings should preferably not be higher than 20 w/w %, preferably be between 16-19 w/w % during the preparation method. It was found that during the method of the invention, the dry matter content in the potato strings does not significantly change upon potato string production as compared with that of the potatoes provided, meaning that the dry matter content may vary during the method by ca. 0.5 w/w %. It is believed that such maintenance of the dry matter content, is important for the pickled potato strings and final consumption quality upon preparation.

Heating is preferably be performed by contacting the potato strings with water or steam of the envisaged temperature.

Importantly, the potato strings are blast chilled after heating in particular to prevent overcooking of the product. The terms ‘blast chilling’ and ‘flash cooling’ have identical meanings and are therefore interchangeably used herein, and are intended to mean that the potato strings are cooled fast to ambient temperature (i.e. to 20-25° C.) or less, i.e. within 25 minutes, preferably within 15 minutes, even more preferably in 10 minutes or less, still even more preferably in 8 minutes or less, still even more preferably in 6 minutes or less and most preferably in 5 minutes or less. Although the above definition prevails, a more general definition of blast chilling is e.g. given in the Brochure NJB0497 Blast Chill Freeze and Thaw Blue Paper November 2009, retrievable from the website http://www.fosterrefrigerator.co.uk The potato strings are contacted with a cooling medium, which can be any suitable cooling medium, preferably a fluid, such as a cooling gas or liquid, e.g. air or water of ambient temperature or below. To optimize cooling, the heat exchange surface between the potato strings and the cooling medium is preferably as large as possible. Preferably, the surface of the potato strings is fully contacted with the cooling medium, e.g. by submersion in a rather large volume of cooling medium in order to minimize contacting of the potato strings with one another during cooling, or by exposing the heated potato strings to a stream of forced air. When a faster flash cooling is preferred, the temperature of the cooling medium can accordingly be chosen lower, but preferably be kept above 0° C.

In a subsequent step, the “pickling step”, the blast chilled potato strings are incubated in a liquid pickling medium having a pH of between 3 and 4.5 at a temperature of least 65° C. Pickling is a known process in the art to confer shelf life to food products. Pickling also confers an acid taste and is also known to change the texture of the food product. It was however surprisingly found that pickled potato strings prepared according to the present invention maintained the texture as from before the pickling step, and result, upon stir-frying, in tudousi having similar texture and bite as compared with unpickled freshly prepared potato strings.

The medium can comprise oil, or is an oil-in-water or water-in-oil emulsion, or an aqueous medium, or an oil free aqueous medium. Oil comprising pickling liquids are e.g. vinaigrette, a mixture of edible oil and vinegar, usually in a 3:1 volume ratio.

The skilled person is very well capable of choosing the proper acid and the amount thereof to arrive at the envisaged pH. It is also possible to mix two or more acids.

The incubation length and temperature in step e) are also known in the art and can conveniently be assessed by the skilled person. The pickling step is preferably performed at pasteurising conditions, known to the skilled person. Incubating at a relatively low elevated temperature (e.g. in the range of 65-80° C.) a longer incubation time may be needed as compared to incubation at a higher temperature (e.g. in the range of 81-95° C.). E.g. at an incubation temperature of 90° C., the incubation time is preferably 35-45 minutes.

The pickling medium can comprise supporting ingredients such as sugars, ascorbic acid, salts, herbs, spices etc. to confer an envisaged taste to the pickled product, e.g. for sour, sweet and sour and sour and spicy.

Herein, the term stir-frying is intended to mean frying at elevated temperature, preferably in oil, wherein, on weight basis, the amount of oil is lower than the amount of the product, in casu the potato strings, to be fried. During frying, the product is stirred, e.g. manually using a wooden spoon or the like. The oil has a temperature of preferably 160-260° C., preferably 220-240° C. The amount of oil, on weight basis, is preferably 1-20% of that of the potato strings, most preferably 2-5%.

The potato strings preferably have a uniform cross-sectional area, preferably over the entire length of the strings. In order to produce potato strings for use in the method of the invention, potatoes are usually cut, in the natural length direction of the tubers, by passing these through a sharpened grid, resulting in a uniform length of the strings.

In a preferred embodiment, the potato strings in step b) are cut to a cross-sectional area of 20 mm² or less, preferably 16 mm² or less, more preferably of 10 mm² or less, most preferably of 7 mm² or less. The said cross-sectional area is preferably at least 3 mm², more preferably at least 4 mm² and most preferably at least 5 mm². When the cross-sectional area becomes too small, the strings have a too large surface to volume ratio and will tend to burn or become overcooked when stir-fried. The larger the cross-sectional area, the more difficult it becomes to produce a stir fried product that is well done.

Preferably, the potato strings are cut, preferably in the natural length direction of the tubers, in step b) to have a rectangular cross-sectional area, preferably a square. As indicated above, cutting into such strings results in less material losses than when cut to cylindrical strings, i.e. a circular cross sectional area. A square form is preferred for practical and economic reasons.

Preferably, at least 80%, preferably at least 90% and most preferably 95% or more of the potato strings in step b) have a length of 30-150 mm, preferably 40-130 mm. Potato strings below 30 mm may result in an incoherent product when stir-fried, whereas strings above 150 mm may result in an over-tangled product during stir-frying, which is difficult to divide into practical portions.

The skilled person will be capable to select the proper heating parameters for potato string heat treatment such as temperature, heating time and the way of heat transfer, such as by incubation of the potato strings in hot water or by treatment with steam, all as function of scale of production and processing equipment available. Preferably, potato strings should meet particular texture requirements after the heating process, before being blast-chilled and pickled. To this end, in step c) the heating is chosen such, that a texture measurement on the heated potato strings after step c) according to the following protocol:
i. loading 160 g of heated potato strings having a cross sectional area of 2.5×2.5 mm, of which at least 90% has a length of 30-150 mm, directly after the said step c) in a chamber having a top and a bottom wall, a height of 40 mm, a length of 100 mm and a width of 70 mm, which top wall has 3 slits, each having a length of 65 mm and a width of 5 mm, the slits having a distance of 2 cm to one another and oriented in parallel to one another, and perpendicular to the axis of the chamber,
ii. closing the chamber,
iii. moving sequentially through each slit in vertical direction towards the bottom wall of the chamber with a speed of 1.0 mm/s over a distance of 24 mm, a probe cutting blade having a lower cutting portion having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion, the length thereof rejuvenating over a height of 34 mm to an upper side having a length of 46 mm and a thickness at the upper side of 2 mm, the thickness of the blade portion rejuvenating from the upper side thereof with an angle of 1° between the front and back side thereof towards the cutting portion, said cutting portion rejuvenating from the upper side thereof with an angle of 6° between the front and back side thereof to the lower sharp cutting edge with a calibrated sharpness of 2.08-2.44 N,
iv. during said moving, measuring the resistance force exerted on the blade as soon as the said force exceeds a threshold of 0.49 N, steps i.-iv. being performed at 60° C.,
v. repeating steps i.-iv., resulting in 6 measurements,
vi. calculating the parameters Fmax (maximum average resistance force) and SA (average surface area, defined as the surface under a graph, reflecting the resistance force curve in time during each measurement of steps iv.) from the 6 measurements wherein outlier values outside the 95% confidence interval by variance analysis (ANOVA) are excluded from the calculation,
   results in an Fmax of at least 12 N above the threshold, and SA of at least 130 Ns.

When the potato strings fulfil the above texture requirements, it has been found that optimal pickled potato strings can be obtained, resulting in an a stir-fried potato product having optimal texture qualities such as bite and crispiness after being stir-fried, while being capable of being stored at ambient temperature. In a first step of the texture measurement, the heated potato strings are allowed to cool down to 60° C., and 160 gram are weighted and put evenly in the container which is subsequently closed. The texture measurement, i.e. steps i.-iv. are performed at 60° C., preferably in a thermostatised room, such as a Peltier cabinet wherein the temperature is regulated to be 60° C. The closed container is preferably at 60° C. Once the potato strings are loaded in the chamber, the chamber is closed and a probe blade of the above described dimensions and sharpness is moved with a constant speed of 1.0 mm/s through the slits and through the potato strings for 2.4 cm, confined in the chamber. The sharpness of the blade is defined by the average of 6 values, obtained by double measurements at three locations on the sharp cutting edge of the blade being uniformly sharpened, i.e. at the middle of the cutting edge between the rounded edges (at 2.65 mm from both edges) and at 1.8 mm from the said middle towards both rounded edges. The measurements are to be performed by using a CATRA Razor Edge Sharpness tester (REST) (CATRA, Henry Street , Sheffield, S3 7EQ, UK) and by applying the suppliers' calibration protocol, the detailed principles of the said standardized test protocol being in the following link (herein incorporated by reference):

www.catra.org/pages/products/kniveslevel1/st.htm
resulting in a sharpness in the above range of 2.08-2.44 N.

As soon as the resistance force of the probe blade reaches a threshold of 0.49N, the said force is registered while the blade continues to move through the confined potato strings. The maximum force is an indication of the crispiness. If the maximum force is too low, it has been found that the resulting stir-fried product after storage gives a too weak, mealy and spongy product. When a force-time curve is produced in a graph showing the resistance force, exerted by the confined potato strings to the probe blade in time, the Fmax reflects the bite or firmness of the potato strings while the SA (surface under the curve) is associated to the amount of labour needed to disintegrate, chew and clear the product upon consumption. If the SA value is too low, the strings are too soft and overdone relative to the target texture profile, which has been found to result in a stir-fried product of bad texture. A total of 6 texture measurements are obtained per potato strings sample, comprised of two triplicate observations on a replicate product sample. Outlier values outside the 95% confidence interval by variance analysis (ANOVA using GenStat 14^{th} Edition software) are excluded from the calculation. Preferably, at most 2 of the 6 calculated values are outside the 95% confidence interval. If more than 2 of the 6 calculated values are outside the said confidence interval, the desired texture requirements are not met. The Fmax is at least 12, preferably 13 N, most preferably 14 N above the threshold. The SA is at least 130 Ns, preferably at least 140 Ns.

If the above texture requirements are met, proper heating conditions are therewith identified to perform the method of the present invention to arrive at ready-to-use pickled potato strings having extended shelf live at ambient temperature for the preparation of tudousi by stir-frying the pickled potato strings. The skilled person is free to choose the heating procedure he prefers, as long as, in this preferred embodiment, the texture values are met.

In another preferred embodiment, the time T_{FP} to reach a first peak on the time-force curve during a texture measurement is 14-21 s, preferably 15-20 s. The time to reach the first peak is an indication about the packing quality of the product in the container. If the first peak is reached too early, i.e. before 14 s, it is an indication that the product is packed too dense or uneven resulting in first peak values before 14 s. If the first peak is realized late in the cycle, i.e. after 21 seconds it is an indication that the container is filled too loose with strings with late first peak timing as result. If time T_{FP} is outside the above range of 14-21 s, or preferably outside 15-20 s, the texture measurement should be repeated by reloading the chamber more evenly, as otherwise, the average resistance force as calculated in step vi. will be unreliable.

In another preferred embodiment, the time T_{FM} to reach Fmax during a texture measurement is 15-24 s. The process of movement of the probe blade through the confined potato strings takes 24 seconds, so the Fmax should preferably be realised relative late during the measurement as force builds gradually up to its maximum during the texture measurement process. The Fmax of a strings sample and the time T_{FM} to reach this value are dependent on two principles, (1) the texture of the product in terms of soft to firm and (2) the quality of the packing of the product in the container in terms of (un)even density. With respect to texture, typical Fmax values between 5-25N can be observed for ready-to-use potato strings, values that are realized between 15 and 24 seconds in the test protocol if the strings are properly evenly packed. An initial hard bite is experienced at Fmax values above 20N, associated with a relative raw or under processed product. Such a bite is less desired for the potato strings of the invention. The same is true when the Fmax is below 12N, indicating an initial soft overcooked texture.

Preferably, the potato strings in step c) are heated to 120° C. or less, preferably to about 100° C. (the term ‘about’ would allow a temperature variation of 5° C. around the indicated value, preferably of 3° C., more preferably 1° C. and most preferably 0° C.). It has been found that at higher temperatures, the heating time is usually short, i.e. below 1 minute, which makes the process to be performed on industrial scale more complicated. The risk of over cooking is relatively high, resulting in a too soft texture. The potato strings in step c) are preferably heated to at least 60° C., more preferably to at least 70° C., even more preferably to at least 80° C.

In step c) of the method of the present invention, the heating time is preferably 360 s. or less, more preferably 240 s. or less, even more preferably 60 s. or less. Shorter times are possible, but from an industrial feasibility point of view, less desired, as explained above. The heating time is preferably at least 30 s., more preferably at least 50s. Preferably, the potato strings in step c) are blanched in boiling water, in particular for 1 minute, or by steam. Good results are obtained when 1 kg of potato strings are blanched during 1 minute in 26 litre of boiling water. However, it should be noted that the texture values Fmax and SA preferably comply with the above values.

It is to be understood that the step of blast chilling, or flash cooling, is preferably performed for 10 minutes or less, more preferably for 8 minutes or less, even more preferably for 6 minutes or less, and most preferably for 5 minutes or less. In a preferred embodiment, blast chilling takes place between ambient temperature and 1° C. lower temperatures are possible, but it is preferred that the potato string do not freeze while being blast chilled. In a preferred embodiment, in step d) the heated potato strings are blast chilled to 15° C. or less, preferably to 10° C. or less, even more preferably to 7° C. or less, and most preferably to 3-5° C., i.e. at a temperature of common household and industrial refrigerators. Blast chilling can be performed in any way known to the skilled person, and suitable flash cooling or blast chilling instruments are known, for example those of Foster, UK. Flash cooling is necessary to stop the cooking process in the strings in order to avoid the strings to become too soft, resulting in impaired shelf life and texture of the stir-fried product.

For optimal cooling, the step of blast chilling preferably comprises contacting the potato strings with a forced stream of cooling fluid, such as cooling gas or air, or a liquid, preferably an aqueous liquid, said cooling fluid preferably having a temperature of between 25° C. and 1° C. In an attractive embodiment, pickling liquid can be chosen as cooling fluid for blast chilling. In that case, the pickling liquid will have a temperature as indicated above, i.e. between 25° C. and 1° C., or any of the described preferred temperatures for blast chilling, which medium is then heated to the envisaged temperature in the pickling step e).

The potato strings preferably have a dry matter content of between 16 and 19 w/w % during the steps of cutting, heating and blast chilling. It has been found that maintaining the dry matter content within this range, results in pickled potato strings with optimal texture, structure and integrity properties, resulting in crunchy tudousi when stir-fried. This is preferably achieved by avoiding oil contact with the potato strings until pickling, preferably until stir-frying, or at least to minimize contact with oil. Preferably, potatoes having a dry matter content of between 16 and 19 w/w % are provided for the preparation of potato strings according to the invention.

In step e), the pickling liquid is preferably an aqueous medium. As outlined above, the pickling liquid can also contain oil, but in view of optimal texture of the potato strings after being kept in the pickling liquid, said pickling liquid is preferably void of oil.

In another preferred embodiment, the pH of the pickling liquid is between 3.5 and 4.3, resulting in optimal taste experience after stir frying.

In a particular embodiment, the pickling liquid comprises an edible acid, in particular chosen from the group, consisting of acetic acid, citric acid, malic acid and lactic acid. Acetic acid is a mild and edible acid particularly suitably for pickling. The amount of acid is chosen such that the envisage pH is obtained.

Vinegar is a common food ingredient and often used for pickling. Therefore, the pickling liquid preferably comprises vinegar, in particular 0.5-5 v/v %, preferably 1-2 v/v % vinegar. Such amounts of vinegar result in the envisaged pH value.

Advantageously, the weight ratio of potato strings:pickling solution is between 4:6 to 6:4, although other ranges are possible as well. However, a higher relative amount of pickling liquid results in unnecessary spoilage of pickling medium, and, if the potato strings are packaged and kept in the pickling solution, an undesired large volume needs to be packaged. On the other hand, if the relative amount of potato strings is higher, suboptimal contact between the pickling liquid and the potato strings may require longer incubation times to ensure the envisaged shelf life.

The incubation temperature in the pickling step is preferably below 100° C., as above 100° C., the chance of loss of texture and bite of the potato strings may become significant. Therefore, the elevated temperature in pickling step e) is preferably between 80 and 95° C., more preferably at about 90° C. The incubation in the pickling step e) at elevated temperature is preferably for at least 20 minutes, more preferably at least 30 minutes, most preferably at least 40 minutes. The incubation at elevated temperature is preferably for at most 120 minutes, more preferably at most 90 minutes, most preferably at most 60 minutes. An incubation time of 40-50 minutes is preferred. The time and duration of the pickling step can be optimized by the skilled person to ensure shelf life and efficient elimination of microbes in the product, while maintaining the crunchiness when stir-fried.

In an attractive embodiment, the pickling step e) comprises filling the blast chilled potato strings of step d) and the pickling liquid in a container and closing the container before incubating the potato strings at elevated temperature. This way, the potato strings are packaged at the beginning of the pickling step, before or at the beginning of incubating at the elevated temperature, and ready for transport, storage or sale after pickling, without any further processing steps being needed. Thus, the potato strings are being kept in the pickling medium, resulting in optimal storage times. In a particularly attractive embodiment, the potato strings are packed in a jar having a lid, in particular a glass jar, the lid being preferably reclosable, e.g. being a screw cap, so that the customer can see the pickled product.

As indicated above, it is also possible to use pickling liquid in the blast chill step d) as cooling liquid. To this end, step d) comprises adding the heated potato strings of step c) to the pickling liquid of step e), said pickling liquid having a temperature of 1-25° C., and step e) comprises heating the pickling liquid comprising the potato strings of step d) to the elevated temperature of at least 65° C. and incubating at the said temperature. By this embodiment, the blast-chilling step and the pickling step are combined in a cost effective manner.

Pickled potato strings prepared according to the invention comply with standard appearance requirements of pickled products in glass jars. The strings keep their initial dimensions in terms of diameter and length upon cutting and blanching. Moreover, the string containing pickling solution remains clear without any leaching of starch granules out of the strings upon pickling. In particular, potato strings prepared from potato varieties or batches that do not fulfil the texture requirements as described above, have a greater chance of developing signs of disintegration in the jars and releasing starch granules in the pickling solution, resulting in turbid pickling liquid and an unattractive appearance of the product.

The described method preferably comprises a step f) of storing the pickled potato strings of step e) in the liquid pickling medium in a closed container, such as a glass jar with a metal screw cap. However, any suitable closable container can be used. No cooling is necessary during said storage. Therefore the storage temperature is preferably ambient temperature, i.e. 18-25° C., preferably 18-22° C. Storage is preferably for at least a month, more preferably for at least 6 months, or even longer, e.g. 1, 2, 3 or 4 years. After storage, the potato strings preferably have substantially the same texture as compared with potato strings, produced from the same batch and treated the same way, but without being pickled. To this end, the potato strings preferably have, after said storage period, at least for one of Fmax or SA as defined above, or for both Fmax and SA, the same value(s) as measured after heating step c).

The texture of the potato strings after being pickled is preferably not impaired during the storage. To this end, at least for one of texture parameters Fmax or SA as defined above, or for both Fmax and SA, the potato strings have the same value(s) after one or more of the above-indicated storage time periods as measured after heating as described above.

As indicated above, contact of potato strings with oil is to be minimized in view of texture, in particular during steps a)-e). It has been found that when contact between the potato strings and oil during the preparation process is avoided, potato strings can be obtained wherein the dry matter content does not significantly increase, and that keep the required qualities such as texture, integrity and structure, resulting in a crispy and crunchy stir-fried product. The claimed method is therefore preferably oil free during steps a)-e), meaning that the potato strings are not contacted with oil as from the moment the potatoes are cut into strings until after blast chilling, but also preferably during the pickling step, preferably until the strings are subjected to a stir-frying step.

The invention also relates to a method for the determination of suitability of a batch of potatoes of a variety or different varieties to be used in the above-described method for the preparation of pickled potato strings or stir-fried pickled potato strings having a texture and bite as described above. In this method, the texture of potato strings is tested after a defined heating step of 3 minutes blanching in boiling water, wherein preferably 1 kilogram of cut potatoes, comprising the following steps:
A) providing peeled potatoes,
B) cutting the peeled potatoes in strings with a cross sectional area of 2.5×2.5 mm, of which at least 90% has a length of 30-150 mm,
C) blanching the said potato strings in boiling water during 3 minutes,
D) loading 160 g of the blanched potato strings in a container having a top and a bottom wall, a height of 40 mm, a length of 100 mm and a width of 70 mm, which top wall has 3 slits, each having a length of 65 mm and a width of 5 mm, the slits having a distance of 2 cm to one another and oriented in parallel to one another, and perpendicular to the axis of the chamber,
E) closing the chamber, moving sequentially through each slit in vertical direction towards the bottom wall of the chamber with a speed of 1.0 mm/s over a distance of 24 mm, a probe cutting blade having a lower cutting portion having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion, the length thereof rejuvenating over a height of 34 mm to an upper side having a length of 46 mm and a thickness at the upper side of 2 mm, the thickness of the blade portion rejuvenating from the upper side thereof with an angle of 1° between the front and back side thereof towards the cutting portion, said cutting portion rejuvenating from the upper side thereof with an angle of 6° between the front and back side thereof to the lower sharp cutting edge with a calibrated sharpness of 2.08-2.44 N,
F) during said moving, measuring the resistance force exerted on the blade as soon as the said force exceeds a threshold of 0.49 N, steps D)-F) being performed at 60° C.,
G) repeating steps D)-G), resulting in 6 measurements,
H) calculating the parameters Fmax (maximum average resistance force) and SA (average surface area, defined as the surface under a graph, reflecting the resistance force curve in time during each measurement of steps G) from the 6 measurements wherein outlier values outside the 95% confidence interval by variance analysis (ANOVA) are excluded from the calculation,
I) determine the potatoes as suitable if the Fmax is at least 12 N above the threshold, and the SA is at least 130 Ns.

The same steps (including those for the determination of the sharpness of the cutting blade) are performed as the previously described texture test to determine proper heating conditions, but now with a predetermined heating step, in order to test the suitability of potatoes as starting material for potato string production. For example, potatoes with a floury cooking behaviour are not very well suited to be used as starting material for the method of the present invention. On the other hand, some batches of potato varieties that can be very suitable to be used in the present method, can be less suitable, due to environmental conditions like certain weather conditions during growth of the potatoes, or storage conditions of the potatoes. Therefore, a suitability test is preferably performed before potato strings according to the present invention are made. Blanching step C) is performed on 1 kg of the potato strings in 26 litre of boiling water. Suitable potatoes, determined according to the above-described method, are therefore advantageously blanched for 1 minute in boiling water when pickled potato strings according to the invention are to be made.

Again, the time T_{FP} to reach the first peak on the curve is preferably 14-21 s, more preferably 15-20 s, the time T_{FM} to reach Fmax is preferably 15-24 s, and the Fmax is preferably at least 13 N, more preferably 14 N above the threshold, and the SA is preferably at least 130 Ns.

According to the methods of the invention, the potatoes of step a) preferably have a dry matter content, expressed as specific gravity, of between 1,040 and 1,080 g/ml, preferably between 1,040 and 1,075 or 1,045 and 1,075 g/ml, more preferably between 1,050 and 1,070 and preferably have a value of 1-4 on the 1-7 waxy/floury scale (Ochsenbein et al., J. Texture Studies 41 (2010) 1-16), more preferably of 1-3, even more preferably of 1-2 and most preferably of 1, meaning that suitable potatoes are waxy. The potatoes of step a) preferably originate from a variety, chosen from the group, consisting of Amandine (CVPO19950969, EU2504), Annabelle (CVPO19990634, EU6935), Franceline (CVPO19952868, EU175), Marilyn (CVPO20042380, EU17273), and varieties derived therefrom. The numbers between brackets refer to corresponding plant breeders rights. It has been shown that by using these varieties, a very attractive pickled potato strings and an attractive stir-fried product can be produced, with very good firmness and crispiness after being stir-fried. It is to be noted that potato varieties for French fries have more floury characteristics and have a higher dry matter content, with a specific gravity of 1,078 or more. Potato varieties having a lower dry matter content have shown to result in undesirable fries having impaired texture properties. For tudousi as prepared by stir-frying the pickled potato strings as described herein, in contrast, potato varieties having lower dry matter content are preferred.

The invention also relates to pickled potato strings, obtainable by the method as described above for the preparation of instant stir-fried potato strings having a shelf life at ambient temperature before stir-frying of at least one to 6 months.

The invention further relates to a method for the preparation of stir-fried pickled potato strings, comprising the step of stir-frying the pickled potato strings, as obtained by the method described herein for the preparation of instant stir-fried potato strings.

The pickled potato strings are preferably stir-fried in oil, wherein the amount of oil, on weight basis, is preferably 1-20% of that of the potato strings, most preferably 2-5%.

Also described is a closed container, comprising potato strings in liquid pickling medium, obtainable by the above-described method. In such closed container, the potato strings are kept in the liquid pickling medium that functions as a preservative while allowing the potato string to remain texture, so that the said potato strings are crunchy upon being stir-fried.

The second aspect of the invention will now be described by way of the following non limiting examples, also referring to FIGS. 1-4 as described above.

### EXAMPLES 6-10

### Example 6: Texture Measurement Protocol for Potato Strings

Potatoes of an envisaged batch of a potato variety are cut in axial direction to strings of 2.5×2.5 mm, having a length of 30-150 mm with a Halide RG200 vegetable cutter equipped with a 2.5×2.5 mm Julienne knife.

1 Kg of the strings of each variety are blanched in a Frymaster (Frymaster—E4 Electric Fryers RE17TC, 17 kW) with 26 litre of boiling water during 3 minutes. The strings are taken from the boiling water, freed from adherent water on a sieve, and 160 g thereof is immediately evenly loaded in a test chamber as described for FIG. 1, after which the lid of the chamber is closed.

A probe blade as depicted in FIG. 2 is sequentially moved through each of the three slits of the test chamber in the direction to the bottom thereof, with a speed of 1 mm/s over a distance of 2.4 cm. During the movement of the probe blade through the chamber, the resistance force, exerted on the blade is recorded as soon as the said force exceeded a trigger threshold of 0.49N.

The moment when a maximum force Fmax is reached, T_{FM}, during the blade movement is recorded as well. To this end, the probe blade is mounted on a Stable Micro Systems TA-X2 Plus texture analyser with associated software (Exponent software version 4.0.9.0, XT Plus Version 0.01178) running in the compression mode at 1 mm/s.

Loading of the potato strings in the test chamber and moving the blade through the test chamber is performed at 60° C. in a Temperature Controlled Peltier Cabinet (XT/PC). This results in three recordings of the resistance force in time.

The above was repeated, resulting in a total 6 recordings per sample of potato strings. Time-force traces of strings samples obtained by the texture analysis protocol with the SMS instrumental design of texture analyser, XT/PC cabinet and probe show typical patterns as shown in FIG. 3A-C, in this case for the variety Franceline. More than 90% of all curves obtained with the experimental design has the shape and pattern of FIG. 3A. An initial gradient in force between 0 and 15 seconds leads to a series of force peaks in the time frame between approximately 15 and 25 seconds. The gradient can be explained by a steady compression of the product by the probe until the product is fully trapped between the knife and the bottom of the container at about 15 seconds runtime. Then the knife starts cutting the strings that are encountered during the remaining runtime with typical spikes as result. The height of the force and associated parameters depend on the texture of the sample and will get further attention in examples 7 and onwards.

The time-force curves are interpreted by SMS software and a defined macro (see table 1) for this purpose into 4 descriptive texture parameters Fmax (the highest peak in the curve), the time to the first peak (T_{FP}), the time to Fmax (T_{FM}) and the surface area under the curve SA as measure for labour conducted during the run.

Despite the care taken during the filling of the container, uneven filling may occur within certain spaces of the container with too high or too low density of strings per unit volume as result. Above average density of strings may lead to curve shapes that differ from those with under average density. The texture analysis protocol therefore preferably comprises a quality control step to remove outlier curves from the 6 texture recordings per sample applying ANOVA analysis as QC tool for the interpretation and classification of the samples for tudousi quality criteria. Analysis of variance (ANOVA using GenStat 14^{th} Edition software) on the data of the texture parameters from 6 time-force curves per sample, as a tool for quality control of collected data, reveals that a small number of curves yields aberrant texture data that significantly deviate from the mean values of the 6 observations at p=0.05 (95% confidence interval, 95% CI). The application of a one-factor ANOVA, as classical variance test, with variety as factor and the texture parameters Fmax or SA typically identifies outliers in the 6 observations per parameter outside the 95% CI according to the ratio between deviations of individual data values from the average (calculated as residues from the average) divided by 2×√(residual variance) from the ANOVA analysis table. Absolute ratio's =/>2 are outside the 95% CI, marked as outliers and removed from the data file prior to the calculation of average Fmax (the highest peak in the curve), the time to the first peak (T_{FP}), the time to Fmax (T_{FM}) and the surface area under the curve SA values per sample. Root cause analysis resulted in the observation that the outlier data for the texture parameters were mainly originating from a curve shape with a low and late gradient in combination with a late first peak in the curve almost at the end of the runtime, between 24 and 25 s (FIG. 3C). In a number of cases a curve (FIG. 3B) with a steep force gradient and an early first peak earlier than 14 s is observed, leading to high SA type outliers. When measurement results as shown in FIGS. 3B and 3C are obtained, these measurements should not be included in the texture analysis. FIG. 3A shows a proper measurement, wherein the first peak is within the proper interval of 14-21 s.

Significant differences for the texture parameters Fmax, T_{FP}, T_{FM} and SA are calculated with variance analysis (ANOVA) and expressed as LSD (Least Significant Difference) values at p=0.05 and presented below data tables if applicable. If data of more than 2, preferably more than 1 of the measurements have to be discarded according to the ANOVA analysis, the conclusion must be drawn that the packing of the potato string sample or samples was not evenly, and that sampling and measurements are to be repeated. In an exceptional case where despite even packing more than two measurements, preferably more than one of the measurements are to be discarded, the strings batch is outside specifications in that it contains a heterogeneous mix of strings that do not meet the quality criteria.

TABLE 9
Software macro settings for time-force curve
interpretation in terms of Fmax, T_{FP}, T_{FM,} and SA.
Program

| | | | | | | | | |
|---|---|---|---|---|---|---|---|---|
| step | setting | unit/mode | R | F | ? | A | I | texture trait |

| | | | | | | |
|---|---|---|---|---|---|---|
| Clear Graph Results | | | | | | |
| Redraw | | | | | | |
| Search Forwards | | | | | | |
| Go to Peak +ve Value | Force | | | | | |
| Set Threshold . . . Force | 25 | g | | | | |
| Mark Value Time | | | X | | | T_{fp} (s) |
| Go to . . . Time | 0 | sec | | | | |
| Go to Abs. +ve Value | Force | N | | | | |
| Mark Value Force | | | X | | | Fmax (N) |
| Go to . . . Time | 0 | sec | | | | |
| Drop Anchor | | | | | | |
| Select Anchor | 1 | Anchor Not Activated | | X | X | |
| Go to Max. Time | | | | | | |
| Search Backwards | | | | | | |
| Go to . . . Time | 25 | sec | | | | |
| Drop Anchor | | | | | | |
| Select Anchor | 2 | Anchor Not Activated | | X | X | |
| Area | Active vs Active | | * | | | SA (Ns) |
| Redraw | | | | | | |
| Go to . . . Time | 0 | sec | | | | |
| Drop Anchor | | | | | | |
| Goto Abs. +ve Value | Force | N | | | | |
| Drop Anchor | | | | | | |
| Time Difference | | | * | | | T_{fmax} (s) |
| Search Forwards | | | | | | |
| Go to Min. Time | | | | | | |

### Example 7: Suitability Test of Potato Samples for Preparation of Pickled Potato Strings

For a producer of pickled potato strings, it is important to be able to assess whether or not envisaged potatoes are suitable to be used as starting material for the said tudousi or not. Performing the texture analysis of the present invention will provide an objective indicator for the suitability of a lot of ware potatoes from a certain variety for this purpose. The indicator has a good predictive power to ascertain that the ware potato lot concerned indeed will deliver a tudousi grade product at the end of the production process.

Potatoes of the varieties Amandine (EU2504), Annabelle (EU6935), Franceline (EU175), Marilyn (EU17273), Cecile (EU14664), Charlotte (NL005990), Leontine (EU21350) and Gourmandine (EU8902), the numbers between brackets referring to corresponding plant breeders rights as indicated above, were peeled and cut in axial direction to strings of 2.5×2.5 mm, having a length of 30-150 mm with a Halide RG200 vegetable cutter equipped with a 2.5×2.5 mm Julienne knife. Upon cutting the strings were washed twice in excess water (weight-water ratio 4) for the removal of starch granules that were liberated in the cutting process.

1 Kg of water washed strings of each variety were blanched in a Frymaster (Frymaster—E4 Electric Fryers RE17TC, 17 kW) with 26 litre of boiling water during 3 minutes. This preparation protocol represents quality control production circumstances to study if ware potato lot is suited for the production of chilled potato strings for retail and food chain use. After blanching, the potato string samples were taken from the boiling water, freed from adherent water on a sieve, and measured for texture using the texture protocol of example 6. Force-time curves of single measurements of the samples, as measured with the texture analyser protocol, from 6 of the 8 varieties covering the texture range are shown in FIGS. 4A-F. The variety names of these examples are depicted in the figures. The time-force curves of the varieties show quite similar patterns to the first peak and peak time T_{FP} in the curve in the 14-21 seconds range and the positioning of Fmax values in the 15-24 s time interval. Table 10 gives an overview of the average Fmax, T_{FP} (also T_{FP}), T_{FM} (also T_{Fmax}) and SA values of the 8 varieties after quality control by ANOVA.

TABLE 10
Predictive quality control protocol for Tudousi suitability
expressed as average parameter values of n = 6 measurements

| | Specific gravity | Fmax | T_{FP} | T_{Fmax} | SA |
|---|---|---|---|---|---|
| Variety | (g/ml) | (N) | (s) | (s) | (Ns) |
| Amandine | 1.070 | 12.0 | 18.1 | 23.0 | 141.0 |
| Annabelle | 1.070 | 15.2 | 18.6 | 20.1 | 178.2 |
| Cecile | 1.078 | 11.3 | 16.2 | 21.0 | 156.0 |
| Charlotte | 1.081 | 9.7 | 15.3 | 19.7 | 127.1 |
| Franceline | 1.075 | 12.0 | 19.1 | 22.5 | 146.3 |
| Gourmandine | 1.078 | 9.7 | 14.7 | 21.6 | 132.0 |
| Leontine | 1.076 | 8.5 | 14.9 | 19.4 | 115.8 |
| Marilyn | 1.070 | 14.1 | 18.4 | 22.9 | 175.4 |
| LSD p = 0.05 | | 1.7 | 3.0 | 3.1 | 32.6 |

According to the texture protocol, the varieties Amandine, Annabelle, Franceline and Marilyn have an average Fmax of 12 N or more, and an average SA of above 130 Ns, indicating that these varieties, at least the tested batches thereof, have a high level of firmness according to the texture measurements and are suitable to be used in the method of the invention to prepare pickled potato strings for tudousi.

### Example 8: Sensorial Quality and Texture of Tudousi

Potatoes of the above-described varieties Amandine, Annabelle, Franceline, Leontine, Marilyn and of the varieties Agria (NL7603), Fontane (EU6748) and Challenger (EU20951) were peeled, cut into strings washed and blanched as described in example 7. However, blanching was performed for 1 minute. This protocol simulates the production of chilled potato strings for retail and food chain use.

The strings were taken from the boiling water, freed from adherent water on a sieve, and subsequently flash cooled to 4° C. within 5 minutes using a Hobart Foster BCF21 blast chiller. Portions of 500 g of the chilled strings were each put in a glass jar of 1000 ml, containing 500 ml of pickling liquid, comprising 1% v/v acetic acid. After filling, the jars were closed with a lined metal screw cap and incubated for 40 minutes at 90° C. and stored for 6 months at ambient temperature.

Subsequently, tudousi was prepared from 200 g of the stored potato strings as follows for the purpose of sensorial appraisal of the samples by a trained panel for a list of sensory attributes.

A pan having a Teflon coating and a diameter of 30 cm was gas-heated for about 90 s, where after 5 ml rice germ oil was put in the pan and heating was continued for another 30 s, so that the temperature in the middle of the pan is about 240° C. At that moment, 200 g of stored potato strings of the invention is loaded in the pan, and stirred each 10 s. After another 30 seconds, i.e. 3 minutes after starting heating the pan, 5 ml of a salt solution (5 g table salt in 0.5 l tap water) was added. Stirring was continued each 10 s. Again 30 s later, the tudousi was put on plates, having a temperature of 65-70° C.

The tudousi samples were evaluated on 6 attributes: (1) appearance in the glass jar, (2) the dominant texture attribute upon the first chew in the mouth, (3) firmness, (4) the main taste sensation upon chewing, (5) mouth clearance as parameter for the time that is needed before the product can be swallowed and (6) the consistency or integrity of strings upon chewing as a disintegration parameter during chewing).

Appearance of the strings in the jars was scored in 3 turbidity classes: clear, turbid, very turbid. The dominant first texture attribute was related to crunchiness and scored as crunchy or not crunchy. Firmness was scored on 3 levels: firm, rather firm and soft. The main taste sensation upon chewing was scored as juicy or starchy. The rate of mouth clearance was scored as fast or slow. The consistency of the strings upon chewing was scored as coherent (when strings can be chewed into smaller coherent pieces) or granular (when strings disintegrate into random granular structures that stick to the mouth palate). See table 11.

To this end a 5 member in house expert panel from HZPC Holland BV) was previously trained in 3 consecutive days for the consistent scoring of the 6 attributes using pickled potato strings samples with wide expression ranges for the attributes of interest. The trained panel was ultimately evaluating the tudousi samples from the 7 varieties in a random order in duplicate according to best sensorial practice (blind, coded, uniform light, according to the given wording).

TABLE 11
Sensorial evaluation of stir-fried pickled tudousi

| | Appearance | | | | | |
|---|---|---|---|---|---|---|
| | pickling | | | | | |
| Variety | liquid | Texture | Firmness | Taste | Clearance | Consistency |
| Amandine | Clear | Crunchy | Firm | Juicy | Fast | Coherent |
| Annabelle | Clear | Crunchy | Firm | Juicy | Fast | Coherent |
| Franceline | Clear | Crunchy | Firm | Juicy | Fast | Coherent |
| Marilyn | Clear | Crunchy | Firm | Juicy | Fast | Coherent |
| Leontine | Turbid | Not | Soft | Starchy | Slow | Granular |
| | | crunchy | | | | |
| Agria | Turbid | Not | Soft | Starchy | Slow | Granular |
| | | crunchy | | | | |
| Fontane | Very turbid | Not | Soft | Starchy | Slow | Granular |
| | | crunchy | | | | |
| Challenger | Very turbid | Not | Rather | Starchy | Slow | Granular |
| | | crunchy | firm | | | |

It can clearly be seen that in particular the varieties Amandine, Annabelle, Franceline and Marilyn, unlike the other 4 varieties, are high in the level of perceived firmness and crunchiness producing strings with a clear appearance in the jar upon pickling. This level of crunchy and firm texture is associated with a juicy texture upon chewing and faster clearance of the product in the mouth. The data of the 4 overlapping varieties of the sensory attributes from table 11 correlate highly with the texture parameters from table 10, indicating that these sensorial attributes can be associated with the texture parameters Fmax and SA as derived from measurements with a texture analyser during the suitability test.

Similar results were obtained when pickling was performed for 1-1.5 hour at 65° C., or for 0.75-1 hour at 80° C., and when the jars were stored for 1 months, or 12 months.

Potato varieties that deliver pickled potato strings according to this invention combine a clear appearance in the jars with crunchy texture, firmness, juiciness, fast clearance and coherent structure of the strings. In particular potato varieties Agria, Fontane and Challenger, which each have a specific gravity of over 1,085 and further do not fulfil the texture requirements as identified herein (data not shown) combine a turbid appearance in jars with lack of crunchy texture, and presence of softness, starchy character, slow clearance and granular structure of the strings.

### Example 9: Determination of the Proper Heating Conditions

Strings as prepared above from the varieties Franceline and Leontine were heated in six different ways.

1: batch-wise blanching as described in example 6 for 1 minute

2: batch-wise blanching as described in example 8 for 3 minutes

3 batch-wise blanching for 5 minutes

4: continuous blanching at 90° C.

5: continuous blanching at 95° C.

6: continuous blanching at 99° C.

Table 12 describes the conditions of the 3 batch-wise processes and 3 continuous production processes for potato strings for the varieties Franceline and Leontine as described in example 7 at increasing heating intensities for the batch process (1 to 5 min blanching time) and the continuous process (blanching with water and steam at temperatures from 90 to 99° C.). These treatments are designed for the identification of the optimal heating time for the potato strings product according to batch and continuous production principles.

TABLE 12
Process parameters in a batch and continuous production process of potato strings
critical process parameters

| | | | | | | | | | | primary | | | | | |
|---|---|---|---|---|---|---|---|---|---|---|---|---|---|---|---|
| | | | | | | | | | | steam/water | | additional | | | |
| nr | process | treatment | medium | temperature | | quantity strings | | energy input | | input | | water input | | total volume | |
| 1 | batch | 1 min blanching | water | 100° | C. | 1 | kg/batch | 17 | kW | 26 | kg | 2 | kg/hr | 26 | l |
| 2 | batch | 3 min blanching | water | 100° | C. | 1 | kg/batch | 17 | kW | 26 | kg | 2 | kg/hr | 26 | l |
| 3 | batch | 5 min blanching | water | 100° | C. | 1 | kg/batch | 17 | kW | 26 | kg | 2 | kg/hr | 26 | l |
| 4 | continuous | 3 min blanching | water & steam | 90° | C. | 1500 | kg/hr | 101 | kW | 150 | kg/hr | 70 | l/hr | 220 | l/hr |
| 5 | continuous | 3 min blanching | water & steam | 95° | C. | 1500 | kg/hr | 105 | kW | 160 | kg/hr | 60 | l/hr | 220 | l/hr |
| 6 | continuous | 3 min blanching | water & steam | 99° | C. | 1500 | kg/hr | 112 | kW | 170 | kg/hr | 50 | l/hr | 220 | l/hr |

Texture measurements as described in example 6 were performed on the strings samples produced by the 6 different treatments and data obtained are summarized in table 13.

TABLE 13
Texture parameters of Franceline and Leontine strings in
a batch and continuous production process after table 12
expressed as average parameter values of n = 6 measurements

| | Franceline | | | | Leontine | | | |
|---|---|---|---|---|---|---|---|---|
| process | Fmax | T_{fp} | T_{Fmax} | SA | Fmax | T_{fp} | T_{Fmax} | SA |
| nr | (N) | (s) | (s) | (Ns) | (N) | (s) | (s) | (Ns) |
| 1 | 15.3 | 17.1 | 21.4 | 152.4 | 12.5 | 16.0 | 19.5 | 129.7 |
| 2 | 15.2 | 17.4 | 21.6 | 150.9 | 10.5 | 15.5 | 19.6 | 117.8 |
| 3 | 12.1 | 15.9 | 21.3 | 130.0 | 8.5 | 15.2 | 19.4 | 95.8 |
| 4 | 15.6 | 16.9 | 21.4 | 154.7 | 12.7 | 15.9 | 19.7 | 130.1 |
| 5 | 15.3 | 17.2 | 21.5 | 151.9 | 9.9 | 15.6 | 19.3 | 116.8 |
| 6 | 12.2 | 15.8 | 20.9 | 127.8 | 8.3 | 15.3 | 19.4 | 97.4 |
| LSD | 1.7 | 3.0 | 3.1 | 32.6 | 1.7 | 3.0 | 3.1 | 32.6 |
| p = 0.05 | | | | | | | | |

The texture data from table 13 indicate that the texture parameters Fmax and SA decrease as a function of blanching time in the batch treatments 1-3 and the continuous process treatments 4-6 for both varieties. The decline is more pronounced for the variety Leontine than for Franceline in line with the (lack of) suitability of these varieties for the potato strings product. For Franceline, the processing window from blanching perspective is preferably between 1 and 3 minutes in the batch process, although 5 minutes also results in texture values within the desired range. For the continuous process, the preferred window comprises 90 and 95° C. under the given conditions, whereas at 99° C. the SA value becomes a bit low. This indicates that blanching time and blanching temperature settings can be optimized when preparing the blanched potato strings intended as basis material for pickled potato strings production and ultimately for tudousi preparation. Over-processing may lead to loss of texture in suitable varieties like Franceline.

Example 10: Preparation of Tudousi and Storage at Different Conditions

The production of tudousi was done by 4 distinct processes that ultimately yield chilled, frozen, freeze dried and pickled products. Potatoes from the variety Annabelle were peeled, cut into strings, washed and blanched as described in example 7 for 1 minute. The blanched product was subsequently further treated in the following 4 ways:
1. Blast chilled to 4° C. in a period of 5 minutes using a Hobart Foster BCF21 blast chiller and packed in 1 kg plastic containers with lid and stored in the refrigerator at 4° C.
2. Blast chilled to −20° C. in 8 minutes using a Hobart Foster BCF21 blast chiller and packed in 1 kg plastic containers with lid and stored in the freezer at −20° C.
3. Blast chilled to −20° C. in 8 minutes using a Hobart Foster BCF21 blast chiller, freeze dried with a Labconco freeze dryer equipped with a sample chamber with heated shelves programmed at 35° C. in 24 hours to 99.8% dry matter and subsequently packed in sealed PE bags in portions of 250g under protective atmosphere and stored at room temperature in darkness.
4. Blast chilled to 4° C. for 5 minutes, transfer in, pickling medium in glass jars, pickled 40 minutes at 90° C. in 1% acetic acid and stored for 1 month.

TABLE 6
preparation and storage conditions of instant tudousi

| description | chilled tudousi | frozen tudousi | freeze dried tudousi | pickled tudousi |
|---|---|---|---|---|
| blanching | 1 minute | 1 minute | 1 minute | 1 minute |
| | 100° C. | 100° C. | 100° C. | 100° C. |
| blast chilling | 5 minutes 4° C. | 8 minutes −20° C. | 8 minutes −20° C. | 5 minutes 4° C. |
| freeze drying | not applicable | not applicable | 24 hours to | not applicable |
| | | | 99.8% dry matter | |
| additional | not applicable | not applicable | not applicable | pickling process 40 |
| processing | | | | minutes at 90° C. |
| | | | | in 1% acetic acid |
| packaging | plastic | plastic | PE bag under | glass jars with |
| | containers with | containers with | protective | screw lid |
| | lid | lid | atmosphere | |
| storage | at 4° C. | at −20° C. | at room | at room |
| | | | temperature | temperature |
| | | | (15-20° C.) | (15-20° C.) |
| | | | in darkness | |

When frozen tudousi is prepared like chilled tudousi according to the protocol of example 8, will the heating process take about 1 minute longer to prepare a ready to eat product with a comparable visual appearance and serving temperature. Prepared tudousi from a frozen condition has similar texture, structure and flavour profiles like the product from chilled origin.

When freeze dried tudousi is rehydrated in water in a ratio of 1 part tudousi: 3 parts water and subsequently prepared like chilled tudousi according to the protocol of example 3, will the heating process take the same time like for the chilled tudousi to prepare a ready to eat product with a comparable visual appearance and serving temperature. Prepared tudousi from a freeze dried origin has similar texture, structure and flavour profiles like the product from chilled or frozen origin.

The tudousi, prepared from the pickled potato strings, had similar texture and structure profiles like the product from chilled origin, but had a more pronounced acid in taste.

1. Method for the preparation of pickled potato strings, comprising the steps of:
a) Providing potatoes,
b) Cutting the potatoes of step a) in strings having a cross-sectional area of 25 mm2 or less,
c) Heating the potato strings of step b) to a temperature of 140° C. or less,
d) Blast chilling the heated potato strings of step c) to ambient temperature or less,
e) Incubating the blast chilled potato strings of step d) in a liquid pickling medium having a pH between 3 and 4.5 at an elevated temperature of at least 65° C.

2. Method according to claim 1, wherein the potato strings in step c) are cut to a cross-sectional area of 20 mm2.

3. Method according to claim 1 , wherein at least 80% of the potato strings in step c) have a length of 30-150 mm.

4. Method according to claim 1, wherein in step c) the heating is chosen such, that a texture measurement on the heated potato strings after step c) according to the following protocol:
i. loading 160 g of heated potato strings having a cross sectional area of 2.5×2.5 mm, of which at least 90% has a length of 30-150 mm, directly after the said step c) in a chamber having a top and a bottom wall, a height of 40 mm, a length of 100 mm and a width of 70 mm, which top wall has 3 slits, each having a length of 65 mm and a width of 5 mm, the slits having a distance of 2 cm to one another and oriented in parallel to one another, and perpendicular to the axis of the chamber,
ii. closing the chamber,
iii. moving sequentially through each slit in vertical direction towards the bottom wall of the chamber with a speed of 1.0 mm/s over a distance of 24 mm, a probe cutting blade having a lower cutting portion 31 having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion 3 the length thereof rejuvenating over a height of 34 mm to an upper side having a length of 46 mm and a thickness at the upper side of 2 mm, the thickness of the blade portion 3 rejuvenating from the upper side thereof with an angle of 1° between the front and back side thereof towards the cutting portion, said cutting portion rejuvenating from the upper side thereof with an angle of 6° between the front and back side thereof to the lower sharp cutting edge with a calibrated sharpness of 2.08-2.44 N,
iv. during said moving, measuring the resistance force exerted on the blade as soon as the said force exceeds a threshold of 0.49 N, steps i-iv being performed at 60° C.,
v. repeating steps i.-iv., resulting in 6 measurements,
vi. calculating the parameters Fmax (maximum average resistance force) and SA (average surface area, defined as the surface under a graph, reflecting the resistance force curve in time during each measurement of steps iv.) from the 6 measurements wherein outlier values outside the 95% confidence interval by variance analysis (ANOVA) are excluded from the calculation, results in an Fmax of at least 12 N above the threshold, and SA of at least 130 Ns.

5. Method according to claim 1, wherein the potato strings in step c) are heated to 120° C. or less.

6. Method according to claim 1, wherein in step c) the heating time is 180 s. or less.

7. Method according to claim 1, wherein in step d) the heated potato strings are blast chilled to 15° C. or less.

8. Method according to claim 1, wherein the potato strings have a dry matter content of between 16 and 19 w/w % during steps b), c) and d).

9. Method according to claim 1, wherein the liquid pickling medium is an aqueous medium, having a pH of between 3.5 and 4.3.

10. Method according to claim 1, wherein the liquid pickling medium comprises an acid chosen from the group consisting of acetic acid, citric acid, malic acid, lactic acid and a combination of two or more thereof

11. Method of claim 1, wherein the elevated temperature in step e) is between 80 and 95° C.

12. Method of claim 1, wherein step e) comprises filling the blast chilled potato strings of step d) and the liquid pickling medium in a container and closing the container before incubating the potato strings at elevated temperature.

13. Method of claim 1, wherein:
step d) comprises adding the heated potato strings of step c) to the liquid pickling medium of step e), said liquid pickling medium having a temperature of 1-25° C., and
step e) comprises heating the liquid pickling medium comprising the potato strings of step d) to the elevated temperature of at least 65° C. and incubating at the said temperature.

14. Method of claim 1, further comprising a step f) of storing the pickled potato strings of step e) in the liquid pickling medium in a closed container.

15. Method according to claim 1, wherein before step a), potatoes are tested for suitability, said test comprising the following steps:
A) providing peeled potatoes,
B) cutting the peeled potatoes in strings with a cross sectional area of 2.5×2.5 mm, of which at least 90% has a length of 30-150 mm,
C) blanching the said potato strings in boiling water during 3 minutes,
D) loading 160 g of the blanched potato strings in a container having a top and a bottom wall, a height of 40 mm, a length of 100 mm and a width of 70 mm, which top wall has 3 slits, each having a length of 65 mm and a width of 5 mm, the slits having a distance of 2 cm to one another and oriented in parallel to one another, and perpendicular to the axis of the chamber,
E) closing the chamber,
F) moving sequentially through each slit in vertical direction towards the bottom wall of the chamber with a speed of 1.0 mm/s over a distance of 24 mm, a probe cutting blade having a lower cutting portion 31 having length of 60 mm and a height of 5.7 mm between a lower side and an upper side thereof, at said lower side a lower sharp cutting edge being arranged having a length of 53 mm, flanked by rounded edges, the upper side of the cutting portion being adjacent to a lower side of a blade portion 3 the length thereof rejuvenating over a height of 34 mm to an upper side having a length of 46 mm and a thickness at the upper side of 2 mm, the thickness of the blade portion 3 rejuvenating from the upper side thereof with an angle of 1° between the front and back side thereof towards the cutting portion, said cutting portion rejuvenating from the upper side thereof with an angle of 6° between the front and back side thereof to the lower sharp cutting edge with a calibrated sharpness of 2.08-2.44 N, during said moving, measuring the resistance force exerted on the blade as soon as the said force exceeds a threshold of 0.49 N, steps D)-F) being performed at 60° C.,
G) repeating steps D)-F), resulting in 6 measurements,
H) calculating the parameters Fmax (maximum average resistance force) and SA (average surface area, defined as the surface under a graph, reflecting the resistance force curve in time during each measurement of steps G) from the 6 measurements wherein outlier values outside the 95% confidence interval by variance analysis (ANOVA) are excluded from the calculation,
I) determine the potatoes as suitable if the Fmax is at least 12 N above the threshold, and the SA is at least 130 Ns.

16. Method according to claim 4, wherein the time TFP to reach the first peak on the time-force curve is 14-21 s.

17. Method according to claim 1, wherein the time TFM to reach Fmax is 15-24 s.

18. Method according to claim 1, wherein the potatoes of step a) or A) have a dry matter content, expressed as specific gravity, of between 1,040 and 1,080 g/ml.

19. Method according to claim 1, wherein the potatoes of step a) or A) originate from a variety, chosen from the group consisting of Amandine (EU2504), Annabelle (EU6935), Franceline (EU175), Marilyn (EU17273), and varieties derived therefrom.

20. Pickled potato strings obtained by the method according to claim 1.
